(19) United States
(12) Patent Application Publication
(10) Pub. No.: US 2021/0029993 A1
(43) Pub. Date: Feb. 4, 2021

(54) SPATIAL INHIBITORS, DETERRENTS AND REPELLENTS FOR MOSQUITOES AND MIDGES

(71) Applicant: BEDOUKIAN RESEARCH, INC., Danbury, CT (US)

(72) Inventors: Robert H. BEDOUKIAN, West Redding, CT (US); Paul J. WELDON, Baltimore, MD (US)

(73) Assignee: BEDOUKIAN RESEARCH, INC., Danbury, CT (US)

(21) Appl. No.: 17/073,933

(22) Filed: Oct. 19, 2020

Related U.S. Application Data
(63) Continuation-in-part of application No. 15/629,801, filed on Jun. 22, 2017.
Application No. 15/629,801 is a continuation of application No. 14/689,526, filed on Apr. 17, 2015, now abandoned.
Application No. 14/689,526 is a continuation of application No. 11/509,767, filed on Aug. 24, 2006, now abandoned.
(60) Provisional application No. 60/711,112, filed on Aug. 25, 2005.

(51) Int. Cl. A01N 35/04; A01N 31/02; A01N 31/04; A01N 31/06; A01N 31/08; A01N 35/02; A01N 35/06; A01N 37/02; A01N 43/20; A01N 49/00; A01N 65/00

(52) U.S. Cl. CPC A01N 35/04; A01N 31/02; A01N 31/04; A01N 31/06; A01N 31/08; Y02A 50/30; A01N 35/06; A01N 37/02; A01N 43/20; A01N 49/00; A01N 65/00; A01N 35/02

(57) ABSTRACT

Certain components of citrus fruits and oxidation products of limonene are effective deterrents, repellents and/or spatial inhibitors for mosquitoes and biting midges. The compounds that have been found to be deterrents, repellents and inhibitors for mosquitoes and biting midges are at least two of neryl acetate, citronellyl acetate, geranyl acetate, hydroxy-p-cymene, citral, α-terpineol, citronellal, linaloyl acetate, citronellol, terpen-4-ol, tetrahydrocarvone, products of oxidized oxidized limonene inclusive of d- and l-carvone, (+) limonene oxide, (−) limonene oxide, cis and trans carveol, a diol and an aldehyde. The compounds are formulated into compositions, capable of releasing a spatially deterring/repelling/inhibiting effective amount of the compound effective against mosquitoes or biting midges, in an amount greater than about 75% by weight, based on the total weight of the composition. The compositions are formulated into delivery systems or vehicles (e.g., candles).

### RELATED APPLICATIONS

This application is a continuation-in-part of U.S. patent application Ser. No. 15/629,801, filed Jun. 22, 2017, which a continuation of U.S. patent application Ser. No. 14/689,526, filed Apr. 17, 2015, which is a continuation of U.S. patent application Ser. No. 11/509,767, filed Aug. 24, 2006, which claims priority from U.S. Provisional Application No. 60/711,112, filed Aug. 25, 2005, all of which are incorporated herein by reference in their entirety.

### BACKGROUND OF THE DISCLOSURE

### 1. Field of the Disclosure

The disclosure relates to improved compounds, compositions and systems for deterring or repelling mosquitoes and biting midges from a target, or providing a spatial inhibitor for preventing mosquitoes and biting midges from sensing or landing on a target, particularly a human target. The disclosure also provides a method of employing such compounds and compositions for deterring or repelling mosquitoes and biting midges from contact with targets or for inhibiting them from sensing or landing on a target.

### 2. Description of the Related Art

In the field of mosquito and biting midge control and repellency many compounds or substances have been employed. For example, DEET® has been employed as a mosquito and biting midge repellent. However, DEET® is a contact repellent that mosquitoes or biting midges avoid when they come into contact with it. Thus, DEET® is applied to the skin of a person to repel mosquitoes or biting midges when they contact the DEET®. However, to many persons DEET® can have irritating or toxic effects and cannot be applied to their skin. Citronella oil has also been shown to have relatively low efficacy for its intended use as a spatial inhibitor. Recently, it has been discovered that certain 3-methyl-1-alkene-3-ols, such as linalool, act as spatial inhibitors, i.e., these compounds inhibit the ability of mosquitoes and biting midges to sense a human target when these compounds are dispensed into an environment.

It has been observed that certain mammals and birds will generally roll on or wipe their integument or skin with fruit, leaves or other plant parts for the apparent purpose of deterring ectoparasites, a phenomenon known as anointing. For this purpose many animals have used lemons (Citrus limona), limes (Citrus aurantilolia) and other citrus fruits as the anointing materials. In many cases, the peels, oils or scents of these fruits are applied by the animals to their integument or skin for this purpose of deterring ectoparasites. The major or chief component of these citrus fruits is limonene (4-isopropenyl-1-methyl-cyclohexane) generally more than 55% and usually about 95%-99% in the peel of these fruits. From this it was assumed or inferred that limonene might be an effective repellent or spatial inhibitor for mosquitoes. However, when limonene was tested against mosquitoes it was not found to be either an effective repellent or spatial inhibitor.

In view of the potential for irritation or toxic effects from the use of DEET® there is a need for other mosquito and biting midge deterrents, repellents and/or spatial inhibitor, and especially for deterrents, repellents or inhibitors that are naturally occurring and provide low risk to consumers and user of such products.

### SUMMARY OF THE DISCLOSURE

It has been discovered that certain components of citrus fruits, peels, rinds or epicarps and oxidation products of the d-limonene contained in the fruit, as well as some closely related materials, are effective mosquito and biting midge deterrents, repellents and or spatial inhibitors for mosquitoes and biting midges. Thus according to this disclosure there is provided a method of deterring, repelling or inhibiting mosquitoes and biting midges from a human or an environmental area, the method comprising providing to the human or the environmental area a deterring/repelling/inhibiting effective amount of at least two compounds selected from neryl acetate, citronellyl acetate, geranyl acetate, 8-hydroxy-p-cymene, citral, α-terpineol, citronellal, linaloyl acetate, citronellol, terpen-4-ol, tetrahydrocarvone, and products of oxidized limonene. The products of oxidized limonene include, but are not limited to, d- and l-carvone, (+) limonene oxide, (−) limonene oxide, cis and trans carveol, a diol and an aldehyde.

The compounds that have been found to be particularly effective contact deterrents/repellents for mosquitoes and biting midges, feeding deterrents/repellents for mosquitoes and biting midges are neryl acetate, citronellyl acetate, geranyl acetate, neryl acetate, hydroxy-p-cymene, citral, α-terpineol, citronellal, linaloyl acetate, citronellol, d- and l-carvone, (+) limonene oxide, (−) limonene oxide, cis and trans carveol, terpen-4-ol, tetrahydrocarvone, and mixtures thereof. The compounds neryl acetate, citronellyl acetate, geranyl acetate, citral, α-terpineol, terpinen-4-ol, citronellal, citronellol, linaloyl acetate, (+)/(−) limonene oxide, products of oxidized limonene, particularly d-carvone, l-carvone and cis and trans carveol, and mixtures thereof have been found to be particularly effective as spatial repellents/inhibitors for mosquitoes and biting midges. The compounds neryl acetate, hydroxy-p-cymene, citronellal, linaloyl acetate, geranyl acetate, α-terpineol, citral, d-carvone, l-carvone, (+) and (−) limonene oxide, cis and trans carveol and tetrahydrocarvone, and mixtures thereof are especially effective as mosquito and biting midges contact repellents/deterrents.

The compounds may be formulated into suitable formulations as topical deterrent, repellent or spatial inhibitor compositions. The use of the compounds of this disclosure for the aforementioned repellency and inhibitory purposes is, for example, but not limited to the following methods. For repelling mosquitoes and biting midges from a human, the method comprises applying to the skin of the human a repellency effective amount of at least two compounds selected from neryl acetate, hydroxy-p-cymene, citral, citronellal, linaloyl acetate, geranyl acetate, α-terpineol, tetrahydrocarvone, and products of oxidized limonene. For use as a spatial repellent/inhibitor the method comprises dispensing into an environmental area where one wants to provide such inhibiting effect, an inhibiting effective amount of at least two inhibitor compounds selected from neryl acetate, citronellyl acetate, geranyl acetate, 8-hydroxy-p-cymene, citral, α-terpineol, terpinen-4-ol, citronellal, citronellol, linaloyl acetate, and products of oxidized limonene. The dispensing may be by way of evaporation of the compound from a delivery system or vehicle, dispersion by an aerosol, or by incorporation of the compounds into granules or powders that can be scattered on the ground, and the like.

In an embodiment, this disclosure relates to a method of spatially deterring, repelling or inhibiting mosquitoes and biting midges. The method involves using a composition capable of releasing a spatially deterring/repelling/inhibiting effective amount of a spatial deterring/repelling/inhibiting compound effective against mosquitoes and biting midges. The composition has (a) a spatial deterring/repelling/inhibiting compound having citral, l-carvone, and optionally citronella, and (b) optionally a carrier. The spatial deterring/repelling/inhibiting compound is present in an amount greater than about 75% by weight, based on the total weight of the composition.

In another embodiment, this disclosure relates to a method of spatially inhibiting the ability of mosquitoes to sense a human. The method involves using a composition capable of releasing a spatially inhibiting effective amount of a spatial inhibiting compound effective against mosquitoes. The composition has (a) a spatial inhibiting compound having citral, l-carvone, and optionally citronella, and (b) optionally a carrier. The spatial inhibiting compound is present in an amount greater than about 75% by weight, based on the total weight of the composition.

In yet another embodiment, this disclosure relates to a composition capable of releasing a spatially deterring/repelling/inhibiting effective amount of a spatial deterring/repelling/inhibiting compound effective against mosquitoes or biting midges. The composition has (a) a spatial deterring/repelling/inhibiting compound having citral, l-carvone, and optionally citronella, and (b) optionally a carrier. The spatial deterring/repelling/inhibiting compound is present in an amount greater than about 75% by weight, based on the total weight of the composition

In still another embodiment, this disclosure relates to a method of spatially deterring, repelling or inhibiting mosquitoes and biting midges. The method involves using a composition capable of releasing a spatially deterring/repelling/inhibiting effective amount of a spatial deterring/repelling/inhibiting compound effective against mosquitoes and biting midges. The composition has (a) a spatial deterring/repelling/inhibiting compound having at least two of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and optionally citronella, and (b) optionally a carrier. The spatial deterring/repelling/inhibiting compound is present in an amount greater than about 75% by weight, based on the total weight of the composition

In another embodiment, this disclosure relates to a composition capable of releasing a spatially deterring/repelling/inhibiting effective amount of a spatial deterring/repelling/inhibiting compound effective against mosquitoes or biting midges. The composition has (a) a spatial deterring/repelling/inhibiting compound having at least two of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and optionally citronella, and (b) optionally a carrier. The spatial deterring/repelling/inhibiting compound is present in an amount greater than about 75% by weight, based on the total weight of the composition.

### BRIEF DESCRIPTION OF THE DRAWINGS

FIG. 1 is a graph of the feeding (feeding deterrent or contact repellency) results of mosquitoes for compounds (components of citrus oils) of this disclosure versus control as tested in the examples.

FIG. 2 is a graph of the flying (spatial inhibition or repellency) results of mosquitoes for compounds (components of citrus oils) of this disclosure versus control as tested in the examples.

FIG. 3 is a graph of the feeding (feeding deterrent or contact repellency) results of mosquitoes for compounds (oxidation products of limonene) of this disclosure versus control as tested in the examples.

FIG. 4 is a graph of the flying (spatial repellency) results of mosquitoes for compounds (oxidation products of limonene) of this disclosure versus control as tested in the examples.

FIG. 5 is a graph of the spatial inhibition/repellency results (% mosquitoes caught) of mosquitoes caught in an American Biophysics Mosquito Magnet Liberty Plus mosquito trap relative to a control without the repellency compounds of this disclosure.

### DESCRIPTION OF THE PREFERRED EMBODIMENTS

In accordance with this disclosure certain components of citrus fruits and the oxidation products of limonene have been discovered to be effective mosquito and biting midge deterrents, repellents and/or spatial inhibitors for mosquitoes and biting midges. The compounds that have been found to be feeding deterrents or contact repellents for mosquitoes and biting midge and/or spatial repellents or inhibitors for mosquitoes and biting midge are neryl acetate, citronellyl acetate, geranyl acetate, hydroxy-p-cymene, citral, α-terpineol, citronellal, linaloyl acetate, citronellol, terpen-4-ol, tetrahydrocarvone, products of oxidized limonene, and mixtures thereof. The products of oxidized limonene include, but are not limited to, d- and l-carvone, (+) limonene oxide, (−) limonene oxide, cis and trans carveol, a diol and an aldehyde.

The compounds neryl acetate, citronellyl acetate, geranyl acetate, hydroxy-p-cymene, citral, α-terpineol, terpinen-4-ol, citronellal, citronellol, d-carvone, l-carvone, cis and trans carveol, linaloyl acetate, and (+)/(−) limonene oxide, and mixtures thereof have been found to be particularly effective as spatial inhibitors for mosquitoes, and neryl acetate, hydroxy-p-cymene, citral, citronellal, linaloyl acetate, geranyl acetate, α-terpineol, d-carvone, l-carvone, (+) and (−) limonene oxide, cis and trans carveol, tetrahydrocarvone, and mixtures thereof are especially effective as contact mosquito repellents. The compounds may be formulated into suitable deterrent/repellent compositions or into suitable spatial inhibitor compositions.

For mosquito and biting midge deterrent/repellency, the deterrent/repellency compounds of this disclosure may be formulated into any compositions suitable for application of a deterrent/repellency effective amount of the deterrent/repellent compound to the skin of a human, typically in an amount greater than about 75% by weight, or an amount of about 77.5% or greater by weight, or an amount of about 80% or greater by weight, or an amount of about 82.5% or greater by weight, or an amount of about 85% or greater by weight, or an amount of about 87.5% or greater by weight, or an amount of about 90% or greater by weight, or an amount of about 92.5% or greater by weight, or an amount of about 95% or greater by weight, or an amount of about 97.5% or greater by weight, based on the total weight of the composition.

For mosquito and biting midge deterrent/repellency, the deterrent/repellency compounds of this disclosure may be formulated into any compositions suitable for application of a deterrent/repellency effective amount of the deterrent/repellent compound to the skin of a human, typically with two compounds (e.g., citral and l-carvone), a weight ratio from about 0.05:1 to about 1:0.05, or from about 0.1:1 to about 1:0.1, or from about 0.15:1 to about 1:0.15, or from about 0.2:1 to about 1:0.2, or from about 0.25:1 to about 1:0.25, or from about 0.3:1 to about 1:0.3, or from about 0.35:1 to about 1:0.35, or from about 0.4:1 to about 1:0.4, or from about 0.45:1 to about 1:0.45, or from about 0.5:1 to about 1:0.5, or from about 0.55:1 to about 1:0.55, or from about 0.6:1 to about 1:0.6, or from about 0.65:1 to about 1:0.65, or from about 0.7:1 to about 1:0.7, or from about 0.75:1 to about 1:0.75, or from about 0.8:1 to about 1:0.8, or from about 0.85:1 to about 1:0.85, or from about 0.9:1 to about 1:0.9, or from about 0.95:1 to about 1:0.95.

For spatial inhibition of the ability of mosquitoes and biting midges to sense a target, the spatial inhibitory compounds of this disclosure may be formulated into any suitable composition suitable to dispense a spatially inhibitory effective amount of the spatial inhibitory compound into a target area of an environmental area in which it is desired to spatially inhibit mosquitoes and biting midges from being able to sense their targets. The spatial inhibitory compounds of this disclosure are formulated in the composition of this disclosure in an amount greater than about 75% by weight, or an amount of about 77.5% or greater by weight, or an amount of about 80% or greater by weight, or an amount of about 82.5% or greater by weight, or an amount of about 85% or greater by weight, or an amount of about 87.5% or greater by weight, or an amount of about 90% or greater by weight, or an amount of about 92.5% or greater by weight, or an amount of about 95% or greater by weight, or an amount of about 97.5% or greater by weight, based on the total weight of the composition.

For spatial inhibition of the ability of mosquitoes and biting midges to sense a target, the spatial inhibitory compounds of this disclosure may be formulated into any suitable composition suitable to dispense a spatially inhibitory effective amount of the spatial inhibitory compound into a target area of an environmental area in which it is desired to spatially inhibit mosquitoes and biting midges from being able to sense their targets. The spatial inhibitory compounds of this disclosure are formulated in the composition of this disclosure, typically with two compounds (e.g., citral and l-carvone), in a weight ratio from about 0.05:1 to about 1:0.05, or from about 0.1:1 to about 1:0.1, or from about 0.15:1 to about 1:0.15, or from about 0.2:1 to about 1:0.2, or from about 0.25:1 to about 1:0.25, or from about 0.3:1 to about 1:0.3, or from about 0.35:1 to about 1:0.35, or from about 0.4:1 to about 1:0.4, or from about 0.45:1 to about 1:0.45, or from about 0.5:1 to about 1:0.5, or from about 0.55:1 to about 1:0.55, or from about 0.6:1 to about 1:0.6, or from about 0.65:1 to about 1:0.65, or from about 0.7:1 to about 1:0.7, or from about 0.75:1 to about 1:0.75, or from about 0.8:1 to about 1:0.8, or from about 0.85:1 to about 1:0.85, or from about 0.9:1 to about 1:0.9, or from about 0.95:1 to about 1:0.95.

A preferred composition of this disclosure has a spatial deterring/repelling/inhibiting compound having citral, l-carvone, and optionally citronella, in which the spatial deterring/repelling/inhibiting compound is present in the composition in an amount greater than about 75% by weight, or an amount of about 77.5% or greater by weight, or an amount of about 80% or greater by weight, or an amount of about 82.5% or greater by weight, or an amount of about 85% or greater by weight, or an amount of about 87.5% or greater by weight, or an amount of about 90% or greater by weight, or an amount of about 92.5% or greater by weight, or an amount of about 95% or greater by weight, or an amount of about 97.5% or greater by weight, based on the total weight of the composition. When used with a delivery system (e.g., candle), the composition dispenses a spatially inhibitory effective amount of the spatial deterring/repelling/inhibiting compound into a target area of an environmental area in which it is desired to spatially inhibit mosquitoes and biting midges from being able to sense their targets.

A preferred composition of this disclosure has a spatial deterring/repelling/inhibiting compound having citral, l-carvone, and optionally citronella, in a weight ratio (citral:l-carvone) from about 0.05:1 to about 1:0.05, or from about 0.1:1 to about 1:0.1, or from about 0.15:1 to about 1:0.15, or from about 0.2:1 to about 1:0.2, or from about 0.25:1 to about 1:0.25, or from about 0.3:1 to about 1:0.3, or from about 0.35:1 to about 1:0.35, or from about 0.4:1 to about 1:0.4, or from about 0.45:1 to about 1:0.45, or from about 0.5:1 to about 1:0.5, or from about 0.55:1 to about 1:0.55, or from about 0.6:1 to about 1:0.6, or from about 0.65:1 to about 1:0.65, or from about 0.7:1 to about 1:0.7, or from about 0.75:1 to about 1:0.75, or from about 0.8:1 to about 1:0.8, or from about 0.85:1 to about 1:0.85, or from about 0.9:1 to about 1:0.9, or from about 0.95:1 to about 1:0.95.

The spatial deterring/repelling/inhibiting compounds of this disclosure may be formulated into any suitable formulation composition using a carrier, such as, for example, solutions, oils, creams, lotions, shampoos, aerosols or the like. The formulated composition may be formulated into suitable delivery systems or vehicle, including but not limited to, delivery systems such as compositions in heated or unheated evaporative devices such as candles, diffusers, and the like. Traditional inert carriers such as, including but not limited to, alcohols, esters and petroleum distillates, can be used to produce compositions or formulations of the spatial deterring/repelling/inhibiting compounds. Another series of carriers include but are not limited to the biodegradable oils, including the Olestra® family of oils, isopropyl myristate and squalane. When the formulation will be used as an aerosol, it is preferable to add a propellant. Suitable propellants include propane, butane, isobutane, dimethyl ether, carbon dioxide, nitrous oxide, nitrogen, and combinations thereof.

The amount of spatial deterring/repelling/inhibiting compounds utilized in any composition or formulation will depend upon the type of formulation used but will be greater than about 75% by weight in an inert carrier.

In an embodiment, the spatially inhibitory effective amount typically ranges from about 0.000005-0.010 grams/hr/ft³, or about 0.00005-0.010 grams/hr/ft³, or about 0.0005-0.010 grams/hr/ft³, or about 0.005-0.010 grams/hr/ft³, in the target base area of the environmental area in which inhibition is to be sought.

As an illustration, a base area in an environmental area is chosen for protection having dimensions 10 feet width×10 feet length×6 feet height, that is 600 cubic feet. An emitting device (e.g., candle) emits at a rate of 0.5 grams/24 hr, that is 0.02 grams/hr, and that is 0.00003 grams/hr/ft³.

In an embodiment, an emitting device preferably emits between about 0.01 grams/hr and about 0.75 grams/hr, or between about 0.02 grams/hr and about 0.5 grams/hr, or between about 0.05 grams/hr and about 0.25 grams/hr.

The environmental area and base area are quantitative criterion. The environmental area is an area in which the spatial deterring/repelling/inhibiting is sought (e.g., an outdoor patio area), and the base area is a target area within the environmental area (e.g., a picnic table positioned on the outdoor patio). The spatially deterring/repelling/inhibiting effective amount particularly defines the amount (i.e., grams), the time (i.e., hours), and the space (i.e., cubic feet) for a target area in an environmental area sought to be protected.

In an embodiment, the compositions of this disclosure have a spatial deterring/repelling/inhibiting compound having citral, l-carvone, and optionally citronella in an amount greater than about 75% by weight, based on the total weight of the composition, that exhibit improved deterring or repelling of mosquitoes and biting midges from a target, and preventing mosquitoes and biting midges from sensing or landing on a target, particularly a human target, as compared to compositions not having a spatial deterring/repelling/inhibiting compound having citral, l-carvone, and optionally citronella in an amount greater than about 75% by weight, based on the total weight of the composition.

In an embodiment, this disclosure provides a method of spatially deterring, repelling or inhibiting mosquitoes and biting midges. The method involves using a composition capable of releasing a spatially deterring/repelling/inhibiting effective amount of a spatial deterring/repelling/inhibiting compound effective against mosquitoes and biting midges. The composition has (a) a spatial deterring/repelling/inhibiting compound having at least two of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and optionally citronella, and (b) optionally a carrier. The spatial deterring/repelling/inhibiting compound is present in the composition in an amount greater than about 75% by weight, based on the total weight of the composition.

In an embodiment, this disclosure provides a composition capable of releasing a spatially deterring/repelling/inhibiting effective amount of a spatial deterring/repelling/inhibiting compound effective against mosquitoes or biting midges. The composition has (a) a spatial deterring/repelling/inhibiting compound having at least two of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and optionally citronella, and (b) optionally a carrier. The combination of spatial deterring/repelling/inhibiting compounds is present in the composition in an amount greater than about 75% by weight, based on the total weight of the composition.

Illustrative combinations or mixtures of spatial deterring/repelling/inhibiting compounds useful in the compositions of this disclosure include, for example, the following:

a) combinations of citral with one or more of d-carvone, l-carvone, citronellal, citronellol, neryl acetate, citronellyl acetate, geranyl acetate, hydroxy-p-cymene, α-terpineol, terpinen-4-ol, cis carveol, trans carveol, linaloyl acetate, (+) limonene oxide, (−) limonene oxide, tetrahydrocarvone, and optionally citronella;

b) combinations of d-carvone with one or more of citral, l-carvone, citronellal, citronellol, neryl acetate, citronellyl acetate, geranyl acetate, hydroxy-p-cymene, α-terpineol, terpinen-4-ol, cis carveol, trans carveol, linaloyl acetate, (+) limonene oxide, (−) limonene oxide, tetrahydrocarvone, and optionally citronella;

c) combinations of l-carvone with one or more of citral, d-carvone, citronellal, citronellol, neryl acetate, citronellyl acetate, geranyl acetate, hydroxy-p-cymene, α-terpineol, terpinen-4-ol, cis carveol, trans carveol, linaloyl acetate, (+) limonene oxide, (−) limonene oxide, tetrahydrocarvone, and optionally citronella;

d) combinations of citronellal with one or more of citral, d-carvone, l-carvone, citronellol, neryl acetate, citronellyl acetate, geranyl acetate, hydroxy-p-cymene, α-terpineol, terpinen-4-ol, cis carveol, trans carveol, linaloyl acetate, (+) limonene oxide, (−) limonene oxide, tetrahydrocarvone, and optionally citronella;

e) combinations of citronellol with one or more of citral, d-carvone, l-carvone, citronellal, neryl acetate, citronellyl acetate, geranyl acetate, hydroxy-p-cymene, α-terpineol, terpinen-4-ol, cis carveol, trans carveol, linaloyl acetate, (+) limonene oxide, (−) limonene oxide, tetrahydrocarvone, and optionally citronella;

f) combinations of neryl acetate with one or more of citral, d-carvone, l-carvone, citronellal, citronellol, citronellyl acetate, geranyl acetate, hydroxy-p-cymene, α-terpineol, terpinen-4-ol, cis carveol, trans carveol, linaloyl acetate, (+) limonene oxide, (−) limonene oxide, tetrahydrocarvone, and optionally citronella;

g) combinations of citronellyl acetate with one or more of citral, d-carvone, l-carvone, citronellal, citronellol, neryl acetate, geranyl acetate, hydroxy-p-cymene, α-terpineol, terpinen-4-ol, cis carveol, trans carveol, linaloyl acetate, (+) limonene oxide, (−) limonene oxide, tetrahydrocarvone, and optionally citronella;

h) combinations of geranyl acetate with one or more of citral, d-carvone, l-carvone, citronellal, citronellol, neryl acetate, citronellyl acetate, hydroxy-p-cymene, α-terpineol, terpinen-4-ol, cis carveol, trans carveol, linaloyl acetate, (+) limonene oxide, (−) limonene oxide, tetrahydrocarvone, and optionally citronella;

i) combinations of hydroxy-p-cymene with one or more of citral, d-carvone, l-carvone, citronellal, citronellol, neryl acetate, citronellyl acetate, geranyl acetate, α-terpineol, terpinen-4-ol, cis carveol, trans carveol, linaloyl acetate, (+) limonene oxide, (−) limonene oxide, tetrahydrocarvone, and optionally citronella;

j) combinations of α-terpineol, with one or more of citral, d-carvone, l-carvone, citronellal, citronellol, neryl acetate, citronellyl acetate, geranyl acetate, hydroxy-p-cymene, terpinen-4-ol, cis carveol, trans carveol, linaloyl acetate, (+) limonene oxide, (−) limonene oxide, tetrahydrocarvone, and optionally citronella;

k) combinations of terpinen-4-ol with one or more of citral, d-carvone, l-carvone, citronellal, citronellol, neryl acetate, citronellyl acetate, geranyl acetate, hydroxy-p-cymene, α-terpineol, cis carveol, trans carveol, linaloyl acetate, (+) limonene oxide, (−) limonene oxide, tetrahydrocarvone, and optionally citronella;

l) combinations of cis carveol, with one or more of citral, d-carvone, l-carvone, citronellal, citronellol, neryl acetate, citronellyl acetate, geranyl acetate, hydroxy-p-cymene, α-terpineol, terpinen-4-ol, trans carveol, linaloyl acetate, (+) limonene oxide, (−) limonene oxide, tetrahydrocarvone, and optionally citronella;

m) combinations of trans carveol with one or more of citral, d-carvone, l-carvone, citronellal, citronellol, neryl acetate, citronellyl acetate, geranyl acetate, hydroxy-p-cymene, α-terpineol, terpinen-4-ol, cis carveol, linaloyl acetate, (+) limonene oxide, (−) limonene oxide, tetrahydrocarvone, and optionally citronella;

n) combinations of linaloyl acetate with one or more of citral, d-carvone, l-carvone, citronellal, citronellol, neryl acetate, citronellyl acetate, geranyl acetate, hydroxy-p-cymene, α-terpineol, terpinen-4-ol, cis carveol, trans carveol, (+) limonene oxide, (−) limonene oxide, tetrahydrocarvone, and optionally citronella;

o) combinations of (+) limonene oxide with one or more of citral, d-carvone, l-carvone, citronellal, citronellol, neryl acetate, citronellyl acetate, geranyl acetate, hydroxy-p-cymene, α-terpineol, terpinen-4-ol, cis carveol, trans carveol, linaloyl acetate, (−) limonene oxide, tetrahydrocarvone, and optionally citronella;

p) combinations of (−) limonene oxide (−) limonene oxide, with one or more of citral, d-carvone, l-carvone, citronellal, citronellol, neryl acetate, citronellyl acetate, geranyl acetate, hydroxy-p-cymene, α-terpineol, terpinen-4-ol, cis carveol, trans carveol, linaloyl acetate, (+) limonene oxide, tetrahydrocarvone, and optionally citronella; and

q) combinations of tetrahydrocarvone with one or more of citral, d-carvone, l-carvone, citronellal, citronellol, neryl acetate, citronellyl acetate, geranyl acetate, hydroxy-p-cymene, α-terpineol, terpinen-4-ol, cis carveol, trans carveol, linaloyl acetate, (+) limonene oxide, (−) limonene oxide, and optionally citronella.

The above combinations of spatial deterring/repelling/inhibiting compounds are present in the compositions of this disclosure in an amount greater than about 75% by weight, based on the total weight of the composition.

It is to be realized that the active compounds of this disclosure may be employed in combination with other components recognized as mosquito deterrents, repellents and/or inhibitors, such as for example, including but not limited to, those spatial inhibitors and repellent compounds disclosed for example in U.S. Pat. No. 6,362,235; and U.S. Patent Application Publication No. 2005/0090563 A1. A preferred inhibitor compound that may be combined with the deterrent, repellent and or/inhibitor compounds of this disclosure is linalool, and especially d-linalool (which is also found in citrus fruits).

The deterrent/repellent/inhibitor compounds of this disclosure may be synthesized or may be obtained from natural oils, such as for example, including but not limited to, coriander, spearmint, lemongrass, caraway, and the like.

The deterrent/repellent/inhibitor compositions of this disclosure may be formulated into any suitable delivery means or system. For example, the formulated composition may be formulated into such suitable delivery systems or vehicle, including but not limited to, delivery systems such as compositions in heated or unheated evaporative devices such as candles or compositions placed in fan driven apparatus, compositions for placement on floors or carpets or the ground, compositions in wrist or ankle bands or the like, and compositions in absorbent materials that may be scattered on the ground or floor. The many other forms in which the active compounds of this disclosure may be delivered will be readily apparent to those skilled in the art.

For mosquito and biting midge deterrent/repellency, the deterrent/repellency compositions of this disclosure may be formulated into any delivery system or vehicle suitable for application of a deterrent/repellency effective amount of the deterrent/repellent compound to the skin of a human, typically in an amount greater than about 0.5% by weight, or an amount of about 1.0% or greater by weight, or an amount of about 5% or greater by weight, or an amount of about 10% or greater by weight, based on the total weight of the delivery system or vehicle.

For mosquito and biting midge deterrent/repellency in a spatial area, the deterrent/repellency compositions of this disclosure may be formulated into any delivery system or vehicle (e.g., candle) suitable for application of a deterrent/repellency effective amount of the deterrent/repellent compound to the spatial area, typically in an amount greater than about 0.5% by weight, or an amount of about 1.0% or greater by weight, or an amount of about 5% or greater by weight, or an amount of about 10% or greater by weight, based on the total weight of the delivery system or vehicle.

For mosquito and biting midge deterrent/repellency in a spatial area, the deterrent/repellency compositions of this disclosure may be formulated into any delivery system or vehicle (e.g., diffusers) suitable for application of a deterrent/repellency effective amount of the deterrent/repellent compound to the spatial area, typically in an amount (if a dilution) greater than about 5% by weight, or an amount of about 10% or greater by weight, or an amount of about 25% or greater by weight, or an amount of about 50% or greater by weight, or an amount of about 75% or greater by weight, or an amount of about 90% or greater by weight, or an amount of about 95% or greater by weight, or an amount of about 100% by weight, based on the total weight of the delivery system or vehicle.

For spatial inhibition of the ability of mosquitoes and biting midges to sense a target, the spatial inhibitory compositions of this disclosure may be formulated into any suitable delivery vehicle or system suitable to dispense a spatially inhibitory effective amount of the spatial inhibitory compound into a target area of an environmental area in which it is desired to spatially inhibit mosquitoes and biting midges from being able to sense their targets. The spatial inhibitory compositions of this disclosure are formulated in the delivery vehicle or system of this disclosure in an amount greater than about 0.5% by weight, or an amount of about 1.0% or greater by weight, or an amount of about 5% or greater by weight, or an amount of about 10% or greater by weight, or an amount of about 15% or greater by weight, or an amount of about 20% or greater by weight, or an amount of about 25% or greater by weight, or an amount of about 30% or greater by weight, based on the total weight of the delivery system or vehicle.

The compositions of this disclosure having one or more deterrent/repellent/inhibitor compounds may exhibit a synergistic effect, i.e., a synergistic deterrent/repellent/inhibitor effect. This disclosure provides synergistic compositions for delivery of a deterring/repelling/inhibiting effective amount of a deterring/repelling/inhibiting compound effective against mosquitoes or biting midges. The composition comprises (a) at least two compounds selected from the group consisting of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and mixtures thereof, and (b) optionally a carrier. A delivery vehicle (e.g., candle) is used for delivery of the at least two compounds to a human or an environment. The synergistic compositions having a combination of the compounds produces a combined effect greater than the sum of the separate effects of the compounds individually.

### EXAMPLES

The following tests were employed to illustrate the efficacy of the compounds of this disclosure to effectively act as mosquito deterrents, repellents or as spatial inhibitors for mosquitoes. The test was conducted at 0900-2100 hours in a walk-in incubator (26° C., 63-80% RH) illuminated by fluorescent lights. Mosquitoes were tested in a two-piece Plexiglas module designed to assess their response to feeding deterrents. The bottom piece of the module was 40×7×4-cm hollow platform supporting six circular wells (diameter=3.8 cm, depth=6 mm). Water (40° C.) flowed through the central cavity of the platform at a rate of 215 ml/min. The top piece of the module consisted of six 4.5×4.0×5.0 cm chambers, the floors of which were fitted with a sliding door positioned over a circular opening 3.5 cm in diameter. Mosquitoes were introduced through an aperture 1 cm in diameter on the front wall of the chambers. For each test, five female mosquitoes (Aedes aegypti) were aspirated into each of five chambers of the top module piece and the apertures were plugged with corks wrapped in plastic film. The wells on the bottom piece of the module were filled with 7 ml of 10% sucrose solution containing ATP (2.9 mg/ml). To each well, 75 μl of green dye (McCormick Food, Hunt Valley, Md.) were added so that those mosquitoes imbibing the sugar solution could be identified when crushed at the end of the tests. Each membrane received 50 ul of acetone or experimental compound solution, applied to 9.6 cm² circular area on 0.1 mm-thick membranes made of nylon mesh in a silicone matrix. The membranes were then placed over each well in contact with the sugar solution.

The circular openings on the floor of each chamber of the top piece of the module were aligned with each membrane-covered well of the bottom piece. The sliding floors of the chambers were then opened allowing mosquitoes access to the membranes. The number of mosquitoes landing on the membranes, and those flying within the apparatus, were recorded each minute for five minutes. After five minutes, any mosquitoes remaining on the membranes were removed with a metal wire, and the door of the floor of each chamber was closed. The top piece of the module was then placed into a freezer for 20 minutes. In the test designed to assess feeding, mosquitoes were removed from the frozen module, crushed on white paper towels, and examined for the presence of green dye to indicate that feeding had occurred. The proportions of mosquitoes feeding per trial were analyzed using a standard generalized linear model with a logit link. Landing and flying scores are repeated measures; five reading were obtained for groups of five mosquitoes. Thus, to maintain independence among the data, the five readings were summed, and then the sums divided by 25 (the maximum score in each category) to create proportions of mosquitoes landing and flying. The proportions were then transferred using the standard variance stabilizing transformation for proportions (sin⁻¹ √y, where y is the proportion), and analyzed using ANOVA (Analysis of Variables)

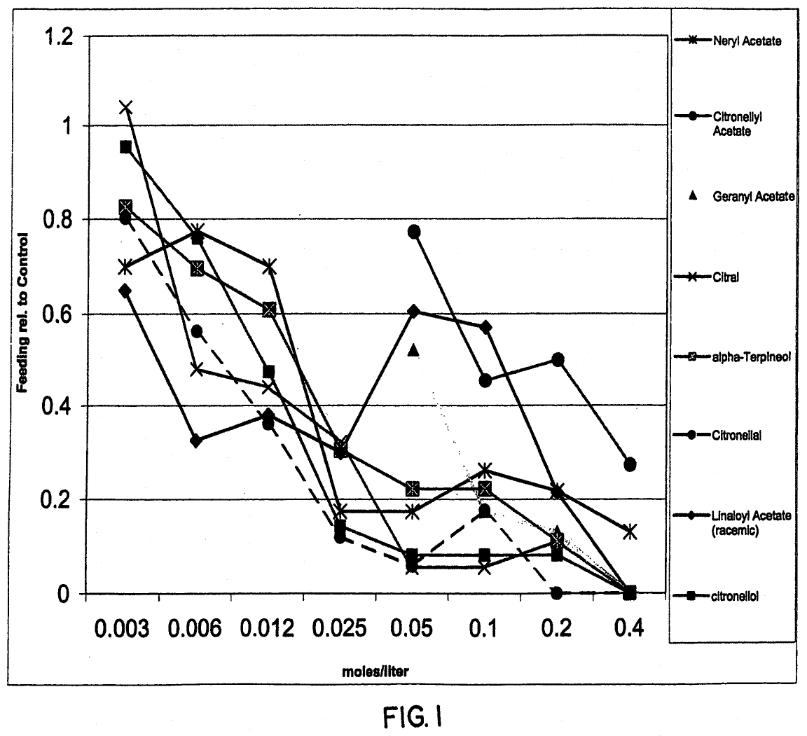

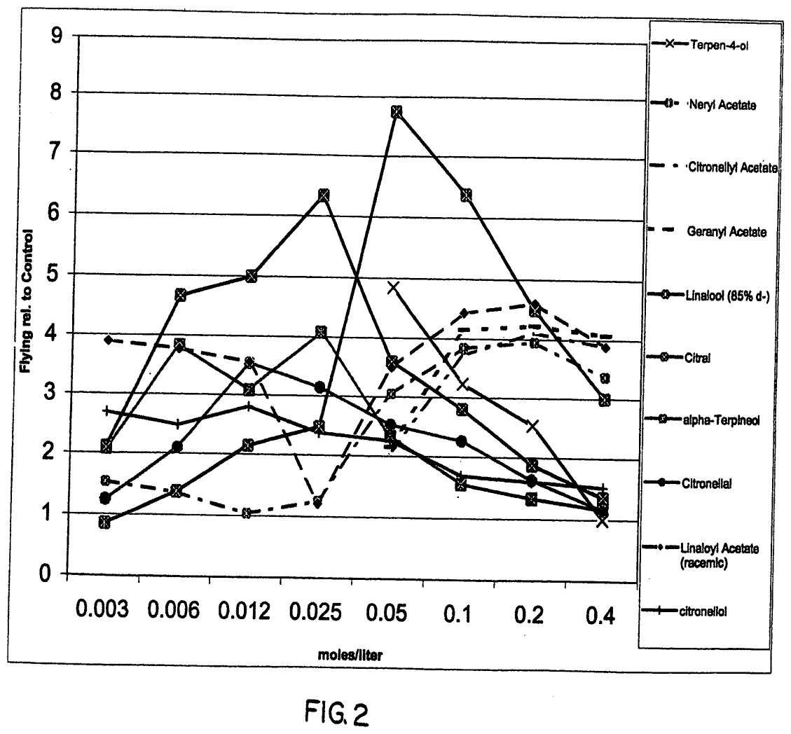

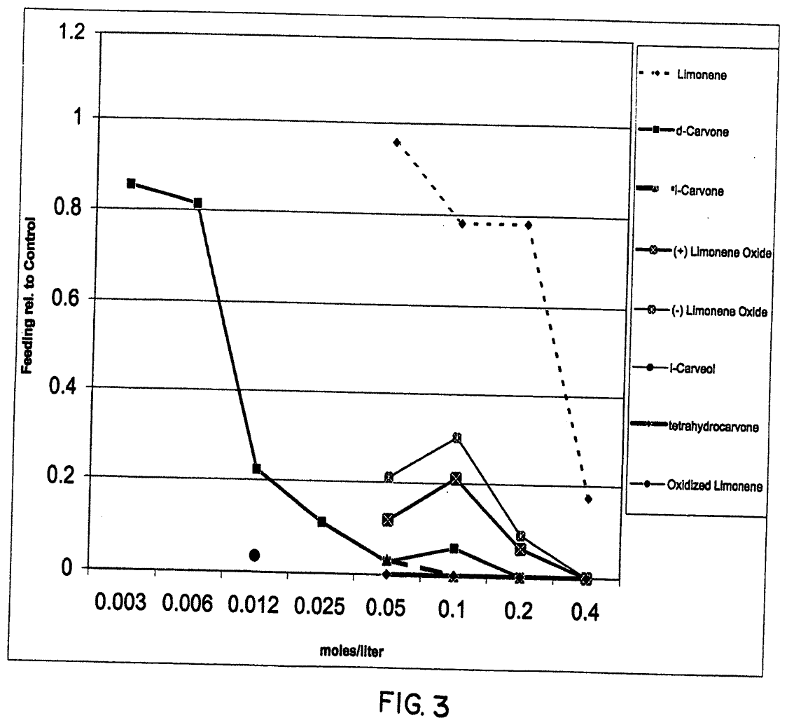

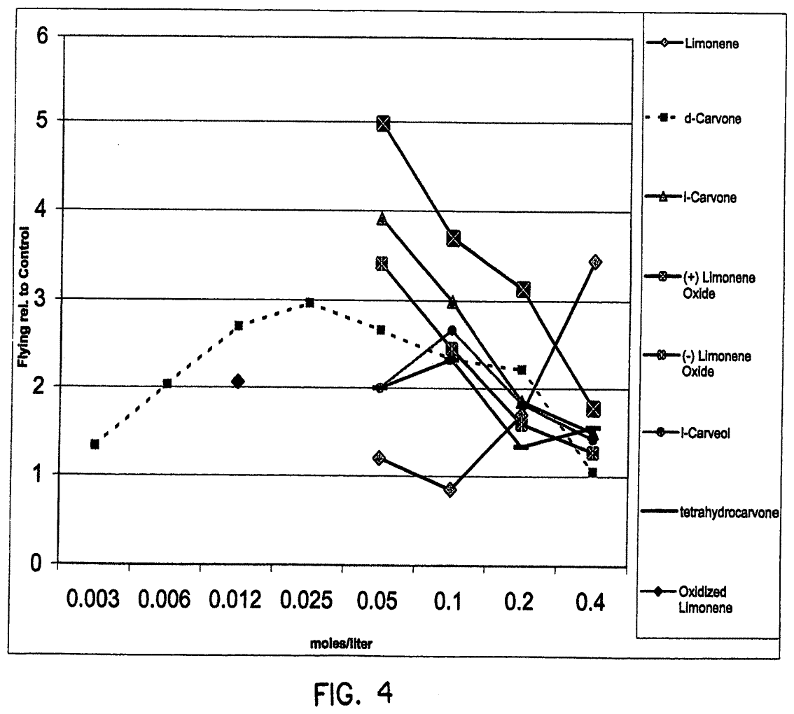

The results of the feeding tests are set forth in FIGS. 1 and 3. In the graphs of FIGS. 1 and 3, the lower the proportion feeding relative to control (1.00) is indicative of the increased repellency activity of the tested compounds. The results of the flying tests are set forth in FIGS. 2 and 4. In the graphs of FIGS. 2 and 4, the higher the number flying relative to the control (1) is indicative of the increased inhibitor activity of the tested compounds. The compounds neryl acetate, citronellyl acetate, geranyl acetate, hydroxy-p-cymene, citral, α-terpineol, terpinen-4-ol, citronellal, citronellol, d-carvone, l-carvone, linaloyl acetate, (+)/(−) limonene oxide and oxidized limonene and mixtures thereof have been found to be particularly effective as spatial inhibitors for mosquitoes, and neryl acetate, citral, citronellal, linaloyl acetate, geranyl acetate, hydroxy-p-cymene, α-terpineol, d-carvone, l-carvone, (+) and (−) limonene oxide, cis and trans carveol and tetrahydrocarvone and oxidized limonene and mixtures thereof have been found to be especially effective as contact mosquito repellents.

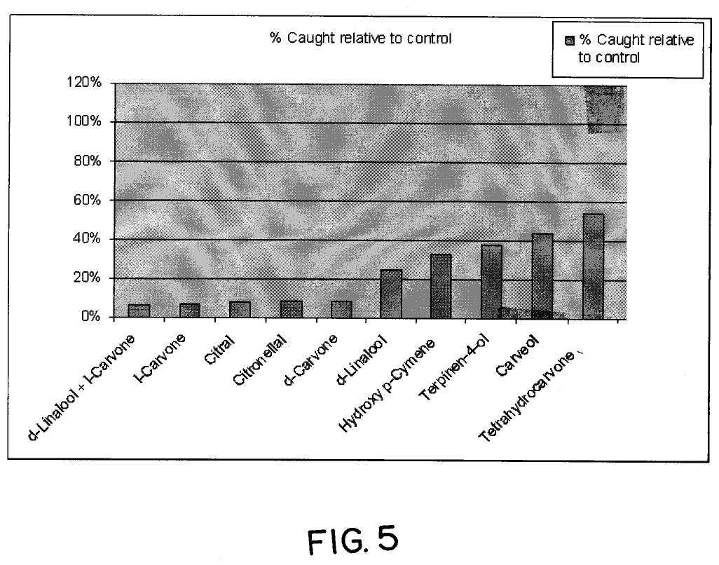

The ability of compounds of this disclosure to spatially inhibit the ability of mosquitoes to sense a target in the outdoors was demonstrated by the following test. Two grams of test compound was absorbed onto pieces of absorbent material. These pieces of absorbent material (fragrance release material from Rhopore Inc.) containing absorbed test compound were then placed in a stream of CO₂ and r-octenol being released from an American Biophysics Mosquito Magnet Liberty Plus mosquito trap designed to attract mosquitoes. The test were rotated over a period of 2-5 days in such a manner that both control (trap without test compound) and test compound were tested an equal number of times in each trap employed. The number of mosquitoes caught in the traps with test compounds was compared to the number of mosquitoes caught in the trap with no test compound material present. That is, the mosquitoes caught with the control were taken to be 100% catch and the catch with the test materials was calculated as a percent of mosquitoes caught relative to the control. Thus, a lowered percentage is indicative of the increasing ability of the test compounds to inhibit the ability of the mosquitoes sense the target. The results are set forth in the Table in FIG. 5. For l-carvone, l-carvone in admixture with the known spatial inhibitor d-linalool, citral, citronellal, d-carvone the percent mosquitoes caught relative to the control was in the range of about 6-8%, indicating a 90+% inhibition of the mosquitoes ability to sense the target trap. Somewhat less effective, but still effective inhibitors were 8-hydroxy-p-cymeme (about 34% relative catch), terpine-4-ol (about 38% relative catch), cis and trans carveol (about 43% relative catch) and tetrahydrocarvone (about 52% relative catch).

The above tests are further employed to illustrate the efficacy of the compounds of this disclosure to effectively act as mosquito deterrents, repellents or as spatial inhibitors for mosquitoes.

The results of the feeding tests for mosquitoes are set forth in Table 1 below. In Table 1, weight percent (wt %) refers to the weight of the deterring/repelling/inhibiting compound, or combination of compounds, in the composition used in the tests. In the “Feeding Relative to Control” column of Table 1, the lower the proportion feeding relative to control (1.00) is indicative of the increased repellency activity of the tested compounds. The weight ratio of the compounds in the combination of compounds is given in parentheses in the “Compound(s)” column of Table 1.

TABLE 1
Mosquitoes Feeding Test Results

| | Weight | Feeding |
|---|---|---|
| | Percent | Relative |
| Compound(s) | (wt %) | To Control |
| Neryl acetate | 77.5 | 0.76 |
| Citronellyl acetate | 80 | 0.65 |
| Geranyl acetate | 85 | 0.68 |
| Citral | 82.5 | 0.60 |
| α-terpineol | 90 | 0.80 |
| Citronellal | 92.5 | 0.62 |
| Linaloyl acetate | 95 | 0.74 |
| Citronellol | 87.5 | 0.62 |
| d-Carvone | 77.5 | 0.64 |
| 1-Carvone | 82.5 | 0.62 |
| (+) Limonene oxide | 87.5 | 0.78 |
| (−) Limonene oxide | 92.5 | 0.76 |
| cis-Carveol | 85 | 0.66 |
| trans-Carveol | 77.5 | 0.64 |
| Hydroxy-p-cymene | 80 | 0.72 |
| Terpinen-4-ol | 90 | 0.74 |
| Tetrahydrocarvone | 95 | 0.70 |
| Citral + 1-Carvone (0.5:0.5) | 77.5 | 0.10 |
| Citral + 1-Carvone + | 77.5 | 0.12 |
| Citronella (0.4:0.4:0.2) | | |
| Citral + 1-Carvone (0.6:0.4) | 82.5 | 0.08 |
| Citral + 1-Carvone + | 82.5 | 0.04 |
| Citronella (0.5:0.25:0.25) | | |
| Citral + 1-Carvone | 85 | 0.06 |
| (0.75:0.25) | | |
| Citral + 1-Carvone + | 85 | 0.02 |
| Citronella (0.25:0.25:0.5) | | |
| Citral + 1-Carvone | 92.5 | 0.10 |
| (0.25:0.75) | | |
| Citral + 1-Carvone + | 92.5 | 0.12 |
| Citronella (0.75:0.15:0.1) | | |
| Citral + 1-Carvone | 95 | 0.08 |
| (0.25:0.75) | | |
| Citral + 1-Carvone + | 95 | 0.06 |
| Citronella (0.75:0.15:0.1) | | |
| Citral + d-Carvone (0.5:0.5) | 77.5 | 0.20 |
| Citral + Citronellal | 77.5 | 0.24 |
| (0.75:0.25) | | |
| Citral + Citronellol | 77.5 | 0.28 |
| (0.75:0.25) | | |
| 1-Carvone + d-Carvone | 77.5 | 0.28 |
| (0.5:0.5) | | |
| 1-Carvone + Citronellal | 77.5 | 0.22 |
| (0.75:0.25) | | |
| 1-Carvone + Citronellol | 77.5 | 0.24 |
| (0.75:0.25) | | |
| d-Carvone + Citronellal | 77.5 | 0.20 |
| (0.75:0.25) | | |
| d-Carvone + Citronellol | 77.5 | 0.26 |
| (0.75:0.25) | 82.5 | 0.36 |
| Citral + Neryl acetate | | |
| (0.5:0.5) | | |
| Citral + Citronellyl acetate | 90 | 0.42 |
| (0.75:0.25) | | |
| Citral + Geranyl acetate | 95 | 0.40 |
| (0.5:0.5) | | |
| Citral + α-terpineol | 77.5 | 0.46 |
| (0.75:0.25) | | |
| Citral + Linaloyl acetate | 92.5 | 0.38 |
| (0.5:0.5) | | |
| Citral + (+) Limonene oxide | 87.5 | 0.32 |
| (0.5:0.5) | | |
| Citral + (−) Limonene oxide | 90 | 0.32 |
| (0.75:0.25) | | |
| Citral + cis-Carveol | 87.5 | 0.40 |
| (0.510.5) | | |
| Citral + trans-Carveol | 82.5 | 0.38 |
| (0.75:0.25) | | |
| Citral + Hydroxy-p-cymene | 80 | 0.44 |
| (0.5:0.5) | | |
| Citral + Terpinen-4-ol | 87.5 | 0.46 |
| (0.75:0.25) | | |
| Citral + Tetrahydrocarvone | 92.5 | 0.40 |
| (0.5:0.5) | | |
| 1-Carvone + Neryl acetate | 77.5 | 0.32 |
| (0.5:0.5) | | |
| 1-Carvone + Citronellyl | 80 | 0.36 |
| acetate (0.75:0.25) | | |
| 1-Carvone + Geranyl acetate | 90 | 0.34 |
| (0.5:0.5) | | |
| 1-Carvone + α-terpineol | 77.5 | 0.42 |
| (0.75:0.25) | | |
| 1-Carvone + Linaloyl | 82.5 | 0.46 |
| acetate (0.5:0.5) | | |
| 1-Carvone + (+) Limonene | 95 | 0.48 |
| oxide (0.5:0.5) | | |
| 1-Carvone + (−) Limonene | 92.5 | 0.46 |
| oxide (0.75:0.25) | | |
| 1-Carvone + cis-Carveol | 80 | 0.38 |
| (0.5:0.5) | | |
| 1-Carvone + trans-Carveol | 77.5 | 0.40 |
| (0.75:0.25) | | |
| 1-Carvone + Hydroxy-p- | 87.5 | 0.46 |
| cymene (0.5:0.5) | | |
| 1-Carvone + Terpinen-4-ol | 85 | 0.48 |
| (0.75:0.25) | | |
| 1-Carvone + | 77.5 | 0.42 |
| Tetrahydrocarvone (0.5:0.5) | | |
| d-Carvone + Neryl acetate | 90 | 0.34 |
| (0.5:0.5) | | |
| d-Carvone + Citronellyl | 92.5 | 0.36 |
| acetate (0.75:0.25) | | |
| d-Carvone + Geranyl | 80 | 0.44 |
| acetate (0.5:0.5) | | |
| d-Carvone + α-terpineol | 77.5 | 0.48 |
| (0.75:0.25) | | |
| d-Carvone + Linaloyl | 90 | 0.46 |
| acetate (0.5:0.5) | | |
| d-Carvone + (+) Limonene | 87.5 | 0.34 |
| oxide (0.5:0.5) | | |
| d-Carvone + (−) Limonene | 85 | 0.40 |
| oxide (0.75:0.25) | | |
| d-Carvone + cis-Carveol | 77.5 | 0.36 |
| (0.5:0.5) | | |
| d-Carvone + trans-Carveol | 92.5 | 0.44 |
| (0.75:0.25) | | |
| d-Carvone + Hydroxy-p- | 95 | 0.46 |
| cymene (0.5:0.5) | | |
| d-Carvone + Terpinen-4-ol | 77.5 | 0.42 |
| (0.75:0.25) | | |
| d-Carvone + | 87.5 | 0.40 |
| Tetrahydrocarvone (0.5:0.5) | | |
| d-Linalool | 80 | 0.32 |
| d-Linalool + 1-Carvone | 82.5 | 0.36 |
| (0.5:0.5) | | |
| d-Linalool + 1-Carvone | 77.5 | 0.34 |
| (0.5:0.5) | | |
| d-Linalool + 1-Carvone | 50 | 0.38 |
| (0.75:0.25) | | |
| d-Linalool + 1-Carvone | 60 | 0.36 |
| (0.25:0.75) | | |

The results of the feeding tests for mosquitoes in Table 1 show excellent deterrent/repellent activity for compositions having combinations of citral+l-carvone, and citral+l-carvone+citronella, at various weight concentrations greater than 75 percent by weight of the compounds in the compositions, and at various weight ratios of the compounds in the compositions. The results of the feeding tests for mosquitoes in Table 1 also show very good deterrent/repellent activity for compositions having various combinations (i.e., two or more compounds) of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and citronella, at various weight concentrations greater than 75 percent by weight of the compounds in the compositions, and at various weight ratios of the compounds in the compositions.

The results of the flying tests for mosquitoes are set forth in Table 2 below. In Table 2, weight percent (wt %) refers to the weight of the deterring/repelling/inhibiting compound, or combination of compounds, in the composition used in the tests. In the “Flying Relative to Control” column in Table 2, the higher the number flying relative to the control (1) is indicative of the increased inhibitor activity of the tested compounds. The weight ratio of the compounds in the combination of compounds is given in parentheses in the “Compound(s)” column of Table 2.

TABLE 2
Mosquitoes Flying Test Results

| | Weight | Flying |
|---|---|---|
| | Percent | Relative |
| Compound(s) | (wt %) | To Control |
| Neryl acetate | 77.5 | 2.0 |
| Citronellyl acetate | 80 | 1.5 |
| Geranyl acetate | 85 | 1.75 |
| Citral | 82.5 | 2.0 |
| α-terpineol | 90 | 1.15 |
| Citronellal | 92.5 | 1.9 |
| Linaloyl acetate | 95 | 1.3 |
| Citronellol | 87.5 | 1.55 |
| d-Carvone | 77.5 | 1.95 |
| l-Carvone | 82.5 | 1.75 |
| (+) Limonene oxide | 87.5 | 0.90 |
| (−) Limonene oxide | 92.5 | 1.1 |
| cis-Carveol | 85 | 1.35 |
| trans-Carveol | 77.5 | 1.55 |
| Hydroxy-p-cymene | 80 | 1.0 |
| Terpinen-4-ol | 90 | 1.7 |
| Tetrahydrocarvone | 95 | 1.65 |
| Citral + l-Carvone (0.5:0.5) | 77.5 | 7.6 |
| Citral + l-Carvone + | 77.5 | 6.8 |
| Citronella (0.4:0.4:0.2) | | |
| Citral + l-Carvone (0.6:0.4) | 82.5 | 6.8 |
| Citral + l-Carvone + | 82.5 | 7.2 |
| Citronella (0.5:0.25:0.25) | | |
| Citral + l-Carvone | 85 | 6.8 |
| (0.75:0.25) | | |
| Citral + l-Carvone + | 85 | 6.4 |
| Citronella (0.25:0.25:0.5) | | |
| Citral + l-Carvone | 92.5 | 6.6 |
| (0.25:0.75) | | |
| Citral + l-Carvone + | 92.5 | 6.4 |
| Citronella (0.75:0.15:0.1) | | |
| Citral + l-Carvone | 95 | 5.8 |
| (0.25:0.75) | | |
| Citral + l-Carvone + | 95 | 6.0 |
| Citronella (0.75:0.15:0.1) | | |
| Citral + d-Carvone (0.5:0.5) | 77.5 | 4.8 |
| Citral + Citronellal | 77.5 | 5.2 |
| (0.75:0.25) | | |
| Citral + Citronellol | 77.5 | 5.0 |
| (0.75:0.25) | | |
| l-Carvone + d-Carvone | 77.5 | 4.6 |
| (0.5:0.5) | | |
| l-Carvone + Citronellal | 77.5 | 5.0 |
| (0.75:0.25) | | |
| l-Carvone + Citronellol | 77.5 | 4.6 |
| (0.75:0.25) | | |
| d-Carvone + Citronellal | 77.5 | 4.8 |
| (0.75:0.25) | | |
| d-Carvone + Citronellol | 77.5 | 5.2 |
| (0.75:0.25) | | |
| Citral + Neryl acetate | 82.5 | 3.2 |
| (0.5:0.5) | | |
| Citral + Citronellyl acetate | 90 | 2.8 |
| (0.75:0.25) | | |
| Citral + Geranyl acetate | 95 | 2.6 |
| (0.5:0.5) | | |
| Citral + α-terpineol | 77.5 | 2.75 |
| (0.75:0.25) | | |
| Citral + Linaloyl acetate | 92.5 | 3.25 |
| (0.5:0.5) | | |
| Citral + (+) Limonene oxide | 87.5 | 3.6 |
| (0.5:0.5) | | |
| Citral + (−) Limonene oxide | 90 | 2.9 |
| (0.75:0.25) | | |
| Citral + cis-Carveol | 87.5 | 3.0 |
| (0.5:0.5) | | |
| Citral + trans-Carveol | 82.5 | 3.55 |
| (0.75:0.25) | | |
| Citral + Hydroxy-p-cymene | 80 | 3.6 |
| (0.5:0.5) | | |
| Citral + Terpinen-4-ol | 87.5 | 2.8 |
| (0.75:0.25) | | |
| Citral + Tetrahydrocarvone | 92.5 | 3.7 |
| (0.5:0.5) | | |
| l-Carvone + Neryl acetate | 77.5 | 2.7 |
| (0.5:0.5) | | |
| l-Carvone + Citronellyl | 80 | 3.15 |
| acetate (0.75:0.25) | | |
| l-Carvone + Geranyl acetate | 90 | 2.45 |
| (0.5:0.5) | | |
| l-Carvone + α-terpineol | 77.5 | 2.85 |
| (0.75:0.25) | | |
| l-Carvone + Linaloyl | 82.5 | 3.45 |
| acetate (0.5:0.5) | | |
| l-Carvone + (+) Limonene | 95 | 3.8 |
| oxide (0.5:0.5) | | |
| l-Carvone + (−) Limonene | 92.5 | 3.2 |
| oxide (0.75:0.25) | | |
| l-Carvone + cis-Carveol | 80 | 2.45 |
| (0.5:0.5) | | |
| l-Carvone + trans-Carveol | 77.5 | 3.15 |
| (0.75:0.25) | | |
| l-Carvone + Hydroxy-p- | 87.5 | 3.2 |
| cymene (0.5:0.5) | | |
| l-Carvone + Terpinen-4-ol | 85 | 3.35 |
| (0.75:0.25) | | |
| l-Carvone + | 77.5 | 2.85 |
| Tetrahydrocarvone (0.5:0.5) | | |
| d-Carvone + Neryl acetate | 90 | 3.4 |
| (0.5:0.5) | | |
| d-Carvone + Citronellyl | 92.5 | 3.55 |
| acetate (0.75:0.25) | | |
| d-Carvone + Geranyl | 80 | 2.85 |
| acetate (0.5:0.5) | | |
| d-Carvone + α-terpineol | 77.5 | 2.9 |
| (0.75:0.25) | | |
| d-Carvone + Linaloyl | 90 | 3.0 |
| acetate (0.5:0.5) | | |
| d-Carvone + (+) Limonene | 87.5 | 3.2 |
| oxide (0.5:0.5) | | |
| d-Carvone + (−) Limonene | 85 | 2.7 |
| oxide (0.75:0.25) | | |
| d-Carvone + cis-Carveol | 77.5 | 2.95 |
| (0.5:0.5) | | |
| d-Carvone + trans-Carveol | 92.5 | 3.7 |
| (0.75:0.25) | | |
| d-Carvone + Hydroxy-p- | 95 | 3.95 |
| cymene (0.5:0.5) | | |
| d-Carvone + Terpinen-4-ol | 77.5 | 3.0 |
| (0.75:0.25) | | |
| d-Carvone + | 87.5 | 3.1 |
| Tetrahydrocarvone (0.5:0.5) | | |
| d-Linalool | 80 | 1.25 |
| d-Linalool + l-Carvone | 82.5 | 2.75 |
| (0.5:0.5) | | |
| d-Linalool + l-Carvone | 77.5 | 3.25 |
| (0.5:0.5) | | |
| d-Linalool + l-Carvone | 50 | 3.15 |
| (0.75:0.25) | | |
| d-Linalool + l-Carvone | 60 | 3.45 |
| (0.25:0.75) | | |

The results of the flying tests for mosquitoes in Table 2 show excellent inhibitor activity for compositions having combinations of citral+l-carvone, and citral+l-carvone+citronella, at various weight concentrations greater than 75 percent by weight of the compounds in the compositions, and at various weight ratios of the compounds in the compositions. The results of the flying tests for mosquitoes in Table 2 also show very good inhibitor activity for compositions having various combinations (i.e., two or more compounds) of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and citronella, at various weight concentrations greater than 75 percent by weight of the compounds in the compositions, and at various weight ratios of the compounds in the compositions.

The above tests are further employed to illustrate the efficacy of the compounds of this disclosure to spatially inhibit the ability of mosquitoes to sense a target in the outdoors.

The results of the spatial inhibition tests for mosquitoes are set forth in Table 3 below. In Table 3, weight percent (wt %) refers to the weight of the deterring/repelling/inhibiting compound, or combination of compounds, in the composition used in the tests. In the “Percent Caught Relative to Control” column in Table 3, a lower percentage is indicative of the increasing ability of the test compounds to inhibit the ability of the mosquitoes sense the target. The weight ratio of the compounds in the combination of compounds is given in parentheses in the “Compound(s)” column of Table 3.

TABLE 3
Spatial Inhibition of Mosquitoes Test Results

| | Weight | Percent Caught |
|---|---|---|
| | Percent | Relative |
| Compound(s) | (wt %) | To Control |
| Neryl acetate | 77.5 | 22 |
| Citronellyl acetate | 80 | 26 |
| Geranyl acetate | 85 | 30 |
| Citral | 82.5 | 10 |
| α-terpineol | 90 | 18 |
| Citronellal | 92.5 | 11 |
| Linaloyl acetate | 95 | 15 |
| Citronellol | 87.5 | 12 |
| d-Carvone | 77.5 | 12 |
| l-Carvone | 82.5 | 10 |
| (+) Limonene oxide | 87.5 | 18 |
| (−) Limonene oxide | 92.5 | 17 |
| cis-Carveol | 85 | 23 |
| trans-Carveol | 77.5 | 22 |
| Hydroxy-p-cymene | 80 | 26 |
| Terpinen-4-ol | 90 | 20 |
| Tetrahydrocarvone | 95 | 25 |
| Citral + l-Carvone (0.5:0.5) | 77.5 | 1 |
| Citral + l-Carvone + | 77.5 | 2 |
| Citronella (0.4:0.4:0.2) | | |
| Citral + l-Carvone (0.6:0.4) | 82.5 | 2 |
| Citral + l-Carvone + | 82.5 | 2 |
| Citronella (0.5:0.25:0.25) | | |
| Citral + l-Carvone | 85 | 1 |
| (0.75:0.25) | | |
| Citral + l-Carvone + | 85 | 2 |
| Citronella (0.25:0.25:0.5) | | |
| Citral + l-Carvone | 92.5 | 1 |
| (0.25:0.75) | | |
| Citral + l-Carvone + | 92.5 | 2 |
| Citronella (0.75:0.15:0.1) | | |
| Citral + l-Carvone | 95 | 2 |
| (0.25:0.75) | | |
| Citral + l-Carvone + | 95 | 1 |
| Citronella (0.75:0.15:0.1) | | |
| Citral + d-Carvone (0.5:0.5) | 77.5 | 4 |
| Citral + Citronellal | 77.5 | 4 |
| (0.75:0.25) | | |
| Citral + Citronellol | 77.5 | 5 |
| (0.75:0.25) | | |
| l-Carvone + d-Carvone | 77.5 | 4 |
| (0.5:0.5) | | |
| l-Carvone + Citronellal | 77.5 | 5 |
| (0.75:0.25) | | |
| l-Carvone + Citronellol | 77.5 | 4 |
| (0.75:0.25) | | |
| d-Carvone + Citronellal | 77.5 | 5 |
| (0.75:0.25) | | |
| d-Carvone + Citronellol | 77.5 | 3 |
| (0.75:0.25) | | |
| Citral + Neryl acetate | 82.5 | 6 |
| (0.5:0.5) | | |
| Citral + Citronellyl acetate | 90 | 10 |
| (0.75:0.25) | | |
| Citral + Geranyl acetate | 95 | 7 |
| (0.5:0.5) | | |
| Citral + α-terpineol | 77.5 | 9 |
| (0.75:0.25) | | |
| Citral + Linaloyl acetate | 92.5 | 8 |
| (0.5:0.5) | | |
| Citral + (+) Limonene oxide | 87.5 | 11 |
| (0.5:0.5) | | |
| Citral + (−) Limonene oxide | 90 | 10 |
| (0.75:0.25) | | |
| Citral + cis-Carveol | 87.5 | 8 |
| (0.5:0.5) | | |
| Citral + trans-Carveol | 82.5 | 9 |
| (0.75:0.25) | | |
| Citral + Hydroxy-p-cymene | 80 | 11 |
| (0.5:0.5) | | |
| Citral + Terpinen-4-ol | 87.5 | 12 |
| (0.75:0.25) | | |
| Citral + Tetrahydrocarvone | 92.5 | 9 |
| (0.5:0.5) | | |
| l-Carvone + Neryl acetate | 77.5 | 8 |
| (0.5:0.5) | | |
| l-Carvone + Citronellyl | 80 | 7 |
| acetate (0.75:0.25) | | |
| l-Carvone + Geranyl acetate | 90 | 10 |
| (0.5:0.5) | | |
| l-Carvone + α-terpineol | 77.5 | 12 |
| (0.75:0.25) | | |
| l-Carvone + Linaloyl | 82.5 | 8 |
| acetate (0.5:0.5) | | |
| l-Carvone + (+) Limonene | 95 | 7 |
| oxide (0.5:0.5) | | |
| l-Carvone + (−) Limonene | 92.5 | 9 |
| oxide (0.75:0.25) | | |
| l-Carvone + cis-Carveol | 80 | 6 |
| (0.5:0.5) | | |
| l-Carvone + trans-Carveol | 77.5 | 9 |
| (0.75:0.25) | | |
| l-Carvone + Hydroxy-p- | 87.5 | 12 |
| cymene (0.5:0.5) | | |
| l-Carvone + Terpinen-4-ol | 85 | 11 |
| (0.75:0.25) | | |
| l-Carvone + | 77.5 | 7 |
| Tetrahydrocarvone (0.5:0.5) | | |
| d-Carvone + Neryl acetate | 90 | 8 |
| (0.5:0.5) | | |
| d-Carvone + Citronellyl | 92.5 | 10 |
| acetate (0.75:0.25) | | |
| d-Carvone + Geranyl | 80 | 10 |
| acetate (0.5:0.5) | | |
| d-Carvone + α-terpineol | 77.5 | 9 |
| (0.75:0.25) | | |
| d-Carvone + Linaloyl | 90 | 7 |
| acetate (0.5:0.5) | | |
| d-Carvone + (+) Limonene | 87.5 | 8 |
| oxide (0.5:0.5) | | |
| d-Carvone + (−) Limonene | 85 | 9 |
| oxide (0.75:0.25) | | |
| d-Carvone + cis-Carveol | 77.5 | 11 |
| (0.5:0.5) | | |
| d-Carvone + trans-Carveol | 92.5 | 10 |
| (0.75:0.25) | | |
| d-Carvone + Hydroxy-p- | 95 | 6 |
| cymene (0.5:0.5) | | |
| d-Carvone + Terpinen-4-ol | 77.5 | 7 |
| (0.75:0.25) | | |
| d-Carvone + | 87.5 | 11 |
| Tetrahydrocarvone (0.5:0.5) | | |
| d-Linalool | 80 | 6 |
| d-Linalool + l-Carvone | 82.5 | 7 |
| (0.5:0.5) | | |
| d-Linalool + l-Carvone | 77.5 | 6 |
| (0.5:0.5) | | |
| d-Linalool + l-Carvone | 50 | 6 |
| (0.75:0.25) | | |
| d-Linalool + l-Carvone | 60 | 7 |
| (0.25:0.75) | | |

The results of the spatial inhibition tests for mosquitoes in Table 3 show excellent spatial inhibition activity for compositions having combinations of citral+l-carvone, and citral+l-carvone+citronella, at various weight concentrations greater than 75 percent by weight of the compounds in the compositions, and at various weight ratios of the compounds in the compositions. The results of the spatial inhibition tests for mosquitoes in Table 3 also show very good spatial inhibition activity for compositions having various combinations (i.e., two or more compounds) of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and citronella, at various weight concentrations greater than 75 percent by weight of the compounds in the compositions, and at various weight ratios of the compounds in the compositions.

The following tests are employed to illustrate the efficacy of the compounds of this disclosure to effectively act as biting midge deterrents, repellents or as spatial inhibitors for biting midges. The testis conducted at 0900-2100 hours in a walk-in incubator (26° C., 63-80% RH) illuminated by fluorescent lights. Biting midges are tested in a two-piece Plexiglas module designed to assess their response to feeding deterrents. The bottom piece of the module is 40×7×4-cm hollow platform supporting six circular wells (diameter=3.8 cm, depth=6 mm). Water (40° C.) flows through the central cavity of the platform at a rate of 215 ml/min. The top piece of the module consists of six 4.5×4.0×5.0 cm chambers, the floors of which are fitted with a sliding door positioned over a circular opening 3.5 cm in diameter. Biting midges are introduced through an aperture 1 cm in diameter on the front wall of the chambers. For each test, five female biting midges (Culicoides impunctatus) are aspirated into each of five chambers of the top module piece and the apertures are plugged with corks wrapped in plastic film. The wells on the bottom piece of the module are filled with 7 ml of 10% sucrose solution containing ATP (2.9 mg/ml). To each well, 77.5 μl of green dye (McCormick Food, Hunt Valley, Md.) are added so that those biting midges imbibing the sugar solution can be identified when crushed at the end of the tests. Each membrane receives 50 μl of acetone or experimental compound solution, applied to 9.6 cm² circular area on 0.1 mm-thick membranes made of nylon mesh in a silicone matrix. The membranes are then placed over each well in contact with the sugar solution.

The circular openings on the floor of each chamber of the top piece of the module are aligned with each membrane-covered well of the bottom piece. The sliding floors of the chambers are then opened allowing biting midges access to the membranes. The number of biting midges landing on the membranes, and those flying within the apparatus, are recorded each minute for five minutes. After five minutes, any biting midges remaining on the membranes are removed with a metal wire, and the door of the floor of each chamber is closed. The top piece of the module is then placed into a freezer for 20 minutes. In the test designed to assess feeding, biting midges are removed from the frozen module, crushed on white paper towels, and examined for the presence of green dye to indicate that feeding had occurred. The proportions of biting midges feeding per trial are analyzed using a standard generalized linear model with a logit link. Landing and flying scores are repeated measures; five readings are obtained for groups of five biting midges. Thus, to maintain independence among the data, the five readings are summed, and then the sums divided by 25 (the maximum score in each category) to create proportions of biting midges landing and flying. The proportions are then transferred using the standard variance stabilizing transformation for proportions (sin⁻¹ √y, where y is the proportion), and analyzed using ANOVA (Analysis of Variables).

The results of the feeding tests for biting midges are set forth in Table 4 below. In Table 4, weight percent (wt %) refers to the weight of the deterring/repelling/inhibiting compound, or combination of compounds, in the composition used in the tests. In the “Feeding Relative to Control” column in Table 4, the lower the proportion feeding relative to control (1.00) is indicative of the increased repellency activity of the tested compounds. The weight ratio of the compounds in the combination of compounds is given in parentheses in the “Compound(s)” column of Table 4.

TABLE 4
Biting Midges Feeding Test Results

| | Weight | Feeding |
|---|---|---|
| | Percent | Relative |
| Compound(s) | (wt %) | To Control |
| Neryl acetate | 77.5 | 0.72 |
| Citronellyl acetate | 80 | 0.67 |
| Geranyl acetate | 85 | 0.64 |
| Citral | 82.5 | 0.60 |
| α-terpineol | 90 | 0.80 |
| Citronellal | 92.5 | 0.64 |
| Linaloyl acetate | 95 | 0.72 |
| Citronellol | 87.5 | 0.64 |
| d-Carvone | 77.5 | 0.65 |
| l-Carvone | 82.5 | 0.62 |
| (+) Limonene oxide | 87.5 | 0.77 |
| (−) Limonene oxide | 92.5 | 0.75 |
| cis-Carveol | 85 | 0.67 |
| trans-Carveol | 77.5 | 0.63 |
| Hydroxy-p-cymene | 80 | 0.73 |
| Terpinen-4-ol | 90 | 0.74 |
| Tetrahydrocarvone | 95 | 0.72 |
| Citral + l-Carvone (0.5:0.5) | 77.5 | 0.12 |
| Citral + l-Carvone + | 77.5 | 0.10 |
| Citronella (0.4:0.4:0.2) | | |
| Citral + l-Carvone (0.6:0.4) | 82.5 | 0.06 |
| Citral + l-Carvone + | 82.5 | 0.08 |
| Citronella (0.5:0.25:0.25) | | |
| Citral + l-Carvone | 85 | 0.04 |
| (0.75:0.25) | | |
| Citral + l-Carvone + | 85 | 0.02 |
| Citronella (0.25:0.25:0.5) | | |
| Citral + l-Carvone | 92.5 | 0.12 |
| (0.25:0.75) | | |
| Citral + l-Carvone + | 92.5 | 0.10 |
| Citronella (0.75:0.15:0.1) | | |
| Citral + l-Carvone | 95 | 0.06 |
| (0.25:0.75) | | |
| Citral + l-Carvone + | 95 | 0.08 |
| Citronella (0.75:0.15:0.1) | | |
| Citral + d-Carvone (0.5:0.5) | 77.5 | 0.22 |
| Citral + Citronellal | 77.5 | 0.24 |
| (0.75:0.25) | | |
| Citral + Citronellol | 77.5 | 0.26 |
| (0.75:0.25) | | |
| l-Carvone + d-Carvone | 77.5 | 0.26 |
| (0.5:0.5) | | |
| l-Carvone + Citronellal | 77.5 | 0.24 |
| (0.75:0.25) | | |
| l-Carvone + Citronellol | 77.5 | 0.26 |
| (0.75:0.25) | | |
| d-Carvone + Citronellal | 77.5 | 0.22 |
| (0.75:0.25) | | |
| d-Carvone + Citronellol | 77.5 | 0.25 |
| (0.75:0.25) | | |
| Citral + Neryl acetate | 82.5 | 0.37 |
| (0.5:0.5) | | |
| Citral + Citronellyl acetate | 90 | 0.44 |
| (0.75:0.25) | | |
| Citral + Geranyl acetate | 95 | 0.41 |
| (0.5:0.5) | | |
| Citral + α-terpineol | 77.5 | 0.47 |
| (0.75:0.25) | | |
| Citral + Linaloyl acetate | 92.5 | 0.36 |
| (0.5:0.5) | | |
| Citral + (+) Limonene oxide | 87.5 | 0.36 |
| (0.5:0.5) | | |
| Citral + (−) Limonene oxide | 90 | 0.31 |
| (0.75:0.25) | | |
| Citral + cis-Carveol | 87.5 | 0.42 |
| (0.5:0.5) | | |
| Citral + trans-Carveol | 82.5 | 0.37 |
| (0.75:0.25) | | |
| Citral + Hydroxy-p-cymene | 80 | 0.45 |
| (0.5:0.5) | | |
| Citral + Terpinen-4-ol | 87.5 | 0.46 |
| (0.75:0.25) | | |
| Citral + Tetrahydrocarvone | 92.5 | 0.42 |
| (0.5:0.5) | | |
| l-Carvone + Neryl acetate | 77.5 | 0.33 |
| (0.5:0.5) | | |
| l-Carvone + Citronellyl | 80 | 0.37 |
| acetate (0.75:0.25) | | |
| l-Carvone + Geranyl acetate | 90 | 0.33 |
| (0.5:0.5) | | |
| l-Carvone + α-terpineol | 77.5 | 0.44 |
| (0.75:0.25) | | |
| l-Carvone + Linaloyl | 82.5 | 0.47 |
| acetate (0.5:0.5) | | |
| l-Carvone + (+) Limonene | 95 | 0.48 |
| oxide (0.5:0.5) | | |
| l-Carvone + (−) Limonene | 92.5 | 0.46 |
| oxide (0.75:0.25) | | |
| l-Carvone + cis-Carveol | 80 | 0.39 |
| (0.5:0.5) | | |
| l-Carvone + trans-Carveol | 77.5 | 0.42 |
| (0.75:0.25) | | |
| l-Carvone + Hydroxy-p- | 87.5 | 0.46 |
| cymene (0.5:0.5) | | |
| l-Carvone + Terpinen-4-ol | 85 | 0.48 |
| (0.75:0.25) | | |
| l-Carvone + | 77.5 | 0.45 |
| Tetrahydrocarvone (0.5:0.5) | | |
| d-Carvone + Neryl acetate | 90 | 0.37 |
| (0.5:0.5) | | |
| d-Carvone + Citronellyl | 92.5 | 0.34 |
| acetate (0.75:0.25) | | |
| d-Carvone + Geranyl | 80 | 0.46 |
| acetate (0.5:0.5) | | |
| d-Carvone + α-terpineol | 77.5 | 0.49 |
| (0.75:0.25) | | |
| d-Carvone + Linaloyl | 90 | 0.48 |
| acetate (0.5:0.5) | | |
| d-Carvone + (+) Limonene | 87.5 | 0.36 |
| oxide (0.5:0.5) | | |
| d-Carvone + (−) Limonene | 85 | 0.41 |
| oxide (0.75:0.25) | | |
| d-Carvone + cis-Carveol | 77.5 | 0.37 |
| (0.5:0.5) | | |
| d-Carvone + trans-Carveol | 92.5 | 0.46 |
| (0.75:0.25) | | |
| d-Carvone + Hydroxy-p- | 95 | 0.45 |
| cymene (0.5:0.5) | | |
| d-Carvone + Terpinen-4-ol | 77.5 | 0.42 |
| (0.75:0.25) | | |
| d-Carvone + | 87.5 | 0.44 |
| Tetrahydrocarvone (0.5:0.5) | | |
| d-Linalool | 80 | 0.31 |
| d-Linalool + l-Carvone | 82.5 | 0.38 |
| (0.5:0.5) | | |
| d-Linalool + l-Carvone | 77.5 | 0.34 |
| (0.5:0.5) | | |
| d-Linalool + l-Carvone | 50 | 0.36 |
| (0.75:0.25) | | |
| d-Linalool + l-Carvone | 60 | 0.36 |
| (0.25:0.75) | | |

The results of the feeding tests for biting midges in Table 4 show excellent deterrent/repellent activity for compositions having combinations of citral+l-carvone, and citral+l-carvone+citronella, at various weight concentrations greater than 75 percent by weight of the compounds in the compositions, and at various weight ratios of the compounds in the compositions. The results of the feeding tests for biting midges in Table 4 also show very good deterrent/repellent activity for compositions having various combinations (i.e., two or more compounds) of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and citronella, at various weight concentrations greater than 75 percent by weight of the compounds in the compositions, and at various weight ratios of the compounds in the compositions.

The results of the flying tests for biting midges are set forth in Table 5 below. In Table 5, weight percent (wt %) refers to the weight of the deterring/repelling/inhibiting compound, or combination of compounds, in the composition used in the tests. In the “Flying Relative to Control” column in Table 5, the higher the number flying relative to the control (1) is indicative of the increased inhibitor activity of the tested compounds. The weight ratio of the compounds in the combination of compounds is given in parentheses in the “Compound(s)” column of Table 5.

TABLE 5
Biting Midges Flying Test Results

| | Weight | Flying |
|---|---|---|
| | Percent | Relative |
| Compound(s) | (wt %) | To Control |
| Neryl acetate | 77.5 | 2.5 |
| Citronellyl acetate | 80 | 1.25 |
| Geranyl acetate | 85 | 1.5 |
| Citral | 82.5 | 2.15 |
| α-terpineol | 90 | 1.5 |
| Citronellal | 92.5 | 1.95 |
| Linaloyl acetate | 95 | 1.2 |
| Citronellol | 87.5 | 1.5 |
| d-Carvone | 77.5 | 1.55 |
| l-Carvone | 82.5 | 1.65 |
| (+) Limonene oxide | 87.5 | 0.95 |
| (−) Limonene oxide | 92.5 | 1.15 |
| cis-Carveol | 85 | 1.25 |
| trans-Carveol | 77.5 | 1.5 |
| Hydroxy-p-cymene | 80 | 1.2 |
| Terpinen-4-ol | 90 | 1.6 |
| Tetrahydrocarvone | 95 | 1.7 |
| Citral + l-Carvone (0.5:0.5) | 77.5 | 7.5 |
| Citral + l-Carvone + | 77.5 | 6.85 |
| Citronella (0.4:0.4:0.2) | | |
| Citral + l-Carvone (0.6:0.4) | 82.5 | 6.7 |
| Citral + l-Carvone + | 82.5 | 7.4 |
| Citronella (0.5:0.25:0.25) | | |
| Citral + l-Carvone | 85 | 6.6 |
| (0.75:0.25) | | |
| Citral + l-Carvone + | 85 | 6.75 |
| Citronella (0.25:0.25:0.5) | | |
| Citral + l-Carvone | 92.5 | 6.45 |
| (0.25:0.75) | | |
| Citral + l-Carvone + | 92.5 | 6.35 |
| Citronella (0.75:0.15:0.1) | | |
| Citral + l-Carvone | 95 | 5.7 |
| (0.25:0.75) | | |
| Citral + l-Carvone + | 95 | 6.25 |
| Citronella (0.75:0.15:0.1) | | |
| Citral + d-Carvone (0.5:0.5) | 77.5 | 4.85 |
| Citral + Citronellal | 77.5 | 5.15 |
| (0.75:0.25) | | |
| Citral + Citronellol | 77.5 | 5.25 |
| (0.75:0.25) | | |
| l-Carvone + d-Carvone | 77.5 | 4.5 |
| (0.5:0.5) | | |
| l-Carvone + Citronellal | 77.5 | 5.2 |
| (0.75:0.25) | | |
| l-Carvone + Citronellol | 77.5 | 4.6 |
| (0.75:0.25) | | |
| d-Carvone + Citronellal | 77.5 | 4.9 |
| (0.75:0.25) | | |
| d-Carvone + Citronellol | 77.5 | 5.1 |
| (0.75:0.25) | | |
| Citral + Neryl acetate | 82.5 | 3.4 |
| (0.5:0.5) | | |
| Citral + Citronellyl acetate | 90 | 2.5 |
| (0.75:0.25) | | |
| Citral + Geranyl acetate | 95 | 2.8 |
| (0.5:0.5) | | |
| Citral + α-terpineol | 77.5 | 2.65 |
| (0.75:0.25) | | |
| Citral + Linaloyl acetate | 92.5 | 3.15 |
| (0.5:0.5) | | |
| Citral + (+) Limonene oxide | 87.5 | 3.8 |
| (0.5:0.5) | | |
| Citral + (−) Limonene oxide | 90 | 2.9 |
| (0.75:0.25) | | |
| Citral + cis-Carveol | 87.5 | 3.4 |
| (0.5:0.5) | | |
| Citral + trans-Carveol | 82.5 | 3.5 |
| (0.75:0.25) | | |
| Citral + Hydroxy-p-cymene | 80 | 3.65 |
| (0.5:0.5) | | |
| Citral + Terpinen-4-ol | 87.5 | 2.85 |
| (0.75:0.25) | | |
| Citral + Tetrahydrocarvone | 92.5 | 3.5 |
| (0.5:0.5) | | |
| l-Carvone + Neryl acetate | 77.5 | 2.75 |
| (0.5:0.5) | | |
| l-Carvone + Citronellyl | 80 | 3.35 |
| acetate (0.75:0.25) | | |
| l-Carvone + Geranyl acetate | 90 | 2.55 |
| (0.5:0.5) | | |
| l-Carvone + α-terpineol | 77.5 | 2.65 |
| (0.75:0.25) | | |
| l-Carvone + Linaloyl | 82.5 | 3.65 |
| acetate (0.5:0.5) | | |
| l-Carvone + (+) Limonene | 95 | 3.85 |
| oxide (0.5:0.5) | | |
| l-Carvone + (−) Limonene | 92.5 | 3.3 |
| oxide (0.75:0.25) | | |
| l-Carvone + cis-Carveol | 80 | 2.4 |
| (0.5:0.5) | | |
| l-Carvone + trans-Carveol | 77.5 | 3.1 |
| (0.75:0.25) | | |
| l-Carvone + Hydroxy-p- | 87.5 | 3.2 |
| cymene (0.5:0.5) | | |
| l-Carvone + Terpinen-4-ol | 85 | 3.3 |
| (0.75:0.25) | | |
| l-Carvone + | 77.5 | 2.85 |
| Tetrahydrocarvone (0.5:0.5) | | |
| d-Carvone + Neryl acetate | 90 | 3.4 |
| (0.5:0.5) | | |
| d-Carvone + Citronellyl | 92.5 | 3.55 |
| acetate (0.75:0.25) | | |
| d-Carvone + Geranyl | 80 | 2.85 |
| acetate (0.5:0.5) | | |
| d-Carvone + α-terpineol | 77.5 | 2.7 |
| (0.75:0.25) | | |
| d-Carvone + Linaloyl | 90 | 3.4 |
| acetate (0.5:0.5) | | |
| d-Carvone + (+) Limonene | 87.5 | 3.2 |
| oxide (0.5:0.5) | | |
| d-Carvone + (−) Limonene | 85 | 2.75 |
| oxide (0.75:0.25) | | |
| d-Carvone + cis-Carveol | 77.5 | 2.9 |
| (0.5:0.5) | | |
| d-Carvone + trans-Carveol | 92.5 | 3.7 |
| (0.75:0.25) | | |
| d-Carvone + Hydroxy-p- | 95 | 3.9 |
| cymene (0.5:0.5) | | |
| d-Carvone + Terpinen-4-ol | 77.5 | 3.15 |
| (0.75:0.25) | | |
| d-Carvone + | 87.5 | 3.1 |
| Tetrahydrocarvone (0.5:0.5) | | |
| d-Linalool | 80 | 1.35 |
| d-Linalool + l-Carvone | 82.5 | 2.7 |
| (0.5:0.5) | | |
| d-Linalool + l-Carvone | 77.5 | 3.5 |
| (0.5:0.5) | | |
| d-Linalool + l-Carvone | 50 | 3.1 |
| (0.75:0.25) | | |
| d-Linalool + l-Carvone | 60 | 3.4 |
| (0.25:0.75) | | |

The results of the flying tests for biting midges in Table 5 show excellent inhibitor activity for compositions having combinations of citral+l-carvone, and citral+l-carvone+citronella, at various weight concentrations greater than 75 percent by weight of the compounds in the compositions, and at various weight ratios of the compounds in the compositions. The results of the flying tests for biting midges in Table 5 also show very good inhibitor activity for compositions having various combinations (i.e., two or more compounds) of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and citronella, at various weight concentrations greater than 75 percent by weight of the compounds in the compositions, and at various weight ratios of the compounds in the compositions.

The ability of compounds of this disclosure to spatially inhibit the ability of biting midges to sense a target in the outdoors is demonstrated by the following test. Two grams of test compound is absorbed onto pieces of absorbent material. These pieces of absorbent material (fragrance release material from Rhopore Inc.) containing absorbed test compound are then placed in a stream of CO₂ and r-octenol being released from a biting midges biting midge trap designed to attract biting midges. The test are rotated over a period of 2-5 days in such a manner that both control (trap without test compound) and test compound are tested an equal number of times in each trap employed. The number of biting midges caught in the traps with test compounds is compared to the number of biting midges caught in the trap with no test compound material present. That is, the biting midges caught with the control are taken to be 100% catch and the catch with the test materials is calculated as a percent of biting midges caught relative to the control. Thus, a lowered percentage is indicative of the increasing ability of the test compounds to inhibit the ability of the biting midges sense the target.

The results of the spatial inhibition tests for biting midges are set forth in Table 6 below. In Table 6, weight percent (wt %) refers to the weight of the deterring/repelling/inhibiting compound, or combination of compounds, in the composition used in the tests. In the “Percent Caught Relative to Control” column in Table 6, a lower percentage is indicative of the increasing ability of the test compounds to inhibit the ability of the biting midges to sense the target. The weight ratio of the compounds in the combination of compounds is given in parentheses in the “Compound(s)” column of Table 6.

TABLE 6
Spatial Inhibition of Biting Midges Test Results

| | Weight | Percent Caught |
|---|---|---|
| | Percent | Relative |
| Compound(s) | (wt %) | To Control |
| Neryl acetate | 77.5 | 20 |
| Citronellyl acetate | 80 | 25 |
| Geranyl acetate | 85 | 29 |
| Citral | 82.5 | 12 |
| α-terpineol | 90 | 16 |
| Citronellal | 92.5 | 12 |
| Linaloyl acetate | 95 | 16 |
| Citronellol | 87.5 | 12 |
| d-Carvone | 77.5 | 13 |
| l-Carvone | 82.5 | 12 |
| (+) Limonene oxide | 87.5 | 19 |
| (−) Limonene oxide | 92.5 | 16 |
| cis-Carveol | 85 | 24 |
| trans-Carveol | 77.5 | 22 |
| Hydroxy-p-cymene | 80 | 25 |
| Terpinen-4-ol | 90 | 21 |
| Tetrahydrocarvone | 95 | 25 |
| Citral + l-Carvone (0.5:0.5) | 77.5 | 2 |
| Citral + l-Carvone + | 77.5 | 1 |
| Citronella (0.4:0.4:0.2) | | |
| Citral + l-Carvone (0.6:0.4) | 82.5 | 1 |
| Citral + l-Carvone + | 82.5 | 2 |
| Citronella (0.5:0.25:0.25) | | |
| Citral + l-Carvone | 85 | 2 |
| (0.75:0.25) | | |
| Citral + l-Carvone + | 85 | 1 |
| Citronella (0.25:0.25:0.5) | | |
| Citral + l-Carvone | 92.5 | 2 |
| (0.25:0.75) | | |
| Citral + l-Carvone + | 92.5 | 1 |
| Citronella (0.75:0.15:0.1) | | |
| Citral + l-Carvone | 95 | 1 |
| (0.25:0.75) | | |
| Citral + l-Carvone + | 95 | 2 |
| Citronella (0.75:0.15:0.1) | | |
| Citral + d-Carvone (0.5:0.5) | 77.5 | 3 |
| Citral + Citronellal | 77.5 | 4 |
| (0.75:0.25) | | |
| Citral + Citronellol | 77.5 | 4 |
| (0.75:0.25) | | |
| l-Carvone + d-Carvone | 77.5 | 5 |
| (0.5:0.5) | | |
| l-Carvone + Citronellal | 77.5 | 4 |
| (0.75:0.25) | | |
| l-Carvone + Citronellol | 77.5 | 4 |
| (0.75:0.25) | | |
| d-Carvone + Citronellal | 77.5 | 4 |
| (0.75:0.25) | | |
| d-Carvone + Citronellol | 77.5 | 3 |
| (0.75:0.25) | | |
| Citral + Neryl acetate | 82.5 | 7 |
| (0.5:0.5) | | |
| Citral + Citronellyl acetate | 90 | 10 |
| (0.75:0.25) | | |
| Citral + Geranyl acetate | 95 | 6 |
| (0.5:0.5) | | |
| Citral + α-terpineol | 77.5 | 11 |
| (0.75:0.25) | | |
| Citral + Linaloyl acetate | 92.5 | 9 |
| (0.5:0.5) | | |
| Citral + (+) Limonene oxide | 87.5 | 11 |
| (0.5:0.5) | | |
| Citral + (−) Limonene oxide | 90 | 10 |
| (0.75:0.25) | | |
| Citral + cis-Carveol | 87.5 | 7 |
| (0.5:0.5) | | |
| Citral + trans-Carveol | 82.5 | 8 |
| (0.75:0.25) | | |
| Citral + Hydroxy-p-cymene | 80 | 11 |
| (0.5:0.5) | | |
| Citral + Terpinen-4-ol | 87.5 | 10 |
| (0.75:0.25) | | |
| Citral + Tetrahydrocarvone | 92.5 | 9 |
| (0.5:0.5) | | |
| l-Carvone + Neryl acetate | 77.5 | 8 |
| (0.5:0.5) | | |
| l-Carvone + Citronellyl | 80 | 7 |
| acetate (0.75:0.25) | | |
| l-Carvone + Geranyl acetate | 90 | 10 |
| (0.5:0.5) | | |
| l-Carvone + α-terpineol | 77.5 | 11 |
| (0.75:0.25) | | |
| l-Carvone + Linaloyl | 82.5 | 9 |
| acetate (0.5:0.5) | | |
| l-Carvone + (+) Limonene | 95 | 8 |
| oxide (0.5:0.5) | | |
| l-Carvone + (−) Limonene | 92.5 | 9 |
| oxide (0.75:0.25) | | |
| l-Carvone + cis-Carveol | 80 | 7 |
| (0.5:0.5) | | |
| l-Carvone + trans-Carveol | 77.5 | 9 |
| (0.75:0.25) | | |
| l-Carvone + Hydroxy-p- | 87.5 | 11 |
| cymene (0.5:0.5) | | |
| l-Carvone + Terpinen-4-ol | 85 | 12 |
| (0.75:0.25) | | |
| l-Carvone + | 77.5 | 8 |
| Tetrahydrocarvone (0.5:0.5) | | |
| d-Carvone + Neryl acetate | 90 | 7 |
| (0.5:0.5) | | |
| d-Carvone + Citronellyl | 92.5 | 10 |
| acetate (0.75:0.25) | | |
| d-Carvone + Geranyl | 80 | 9 |
| acetate (0.5:0.5) | | |
| d-Carvone + α-terpineol | 77.5 | 9 |
| (0.75:0.25) | | |
| d-Carvone + Linaloyl | 90 | 8 |
| acetate (0.5:0.5) | | |
| d-Carvone + (+) Limonene | 87.5 | 8 |
| oxide (0.5:0.5) | | |
| d-Carvone + (−) Limonene | 85 | 7 |
| oxide (0.75:0.25) | | |
| d-Carvone + cis-Carveol | 77.5 | 11 |
| (0.5:0.5) | | |
| d-Carvone + trans-Carveol | 92.5 | 10 |
| (0.75:0.25) | | |
| d-Carvone + Hydroxy-p- | 95 | 8 |
| cymene (0.5:0.5) | | |
| d-Carvone + Terpinen-4-ol | 77.5 | 7 |
| (0.75:0.25) | | |
| d-Carvone + | 87.5 | 10 |
| Tetrahydrocarvone (0.5:0.5) | | |
| d-Linalool | 80 | 6 |
| d-Linalool + l-Carvone | 82.5 | 6 |
| (0.5:0.5) | | |
| d-Linalool + l-Carvone | 77.5 | 7 |
| (0.5:0.5) | | |
| d-Linalool + l-Carvone | 50 | 7 |
| (0.75:0.25) | | |
| d-Linalool + l-Carvone | 60 | 6 |
| (0.25:0.75) | | |

The results of the spatial inhibition tests for biting midges in Table 6 show excellent spatial inhibition activity for compositions having combinations of citral+l-carvone, and citral+l-carvone+citronella, at various weight concentrations greater than 75 percent by weight of the compounds in the compositions, and at various weight ratios of the compounds in the compositions. The results of the spatial inhibition tests for biting midges in Table 6 also show very good spatial inhibition activity for compositions having various combinations (i.e., two or more compounds) of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and citronella, at various weight concentrations greater than 75 percent by weight of the compounds in the compositions, and at various weight ratios of the compounds in the compositions.

For repellency of mosquitoes, the compounds of this disclosure may be applied to the skin of human in any repellency effective amount. For spatial inhibition of the ability of mosquitoes to sense a target, or for spatial repellency, the compounds of this disclosure may be dispensed into the atmosphere in any inhibiting effective amount.

While the disclosure has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

What is claimed is:

1. A method of spatially deterring, repelling or inhibiting mosquitoes and biting midges, the method comprising using a composition capable of releasing a spatially deterring/repelling/inhibiting effective amount of a spatial deterring/repelling/inhibiting compound effective against mosquitoes and biting midges, said composition comprising (a) a spatial deterring/repelling/inhibiting compound comprising citral, l-carvone, and optionally citronella, and (b) optionally a carrier, wherein the spatial deterring/repelling/inhibiting compound is present in an amount greater than about 75% by weight, based on the total weight of the composition.

2. The method according to claim 1 wherein the spatial deterring/repelling/inhibiting compound is present in an amount of about 80% or greater by weight, based on the total weight of the composition.

3. The method according to claim 1 wherein the citral and l-carvone are present in a weight ratio from about 0.05:1 to about 1:0.05.

4. The method according to claim 1 for spatially deterring/repelling/inhibiting mosquitoes.

5. The method according to claim 1 wherein the spatial deterring/repelling/inhibiting compound is present in a carrier in a spatially inhibitory effective amount sufficient for spatially inhibiting mosquitoes or biting midges from being able to sense their targets.

6. The method according to claim 1 wherein the composition is capable of releasing from about 0.000005-0.010 grams/hr/ft³ of the spatial deterring/repelling/inhibiting compound effective against mosquitoes and biting midges.

7. A method of spatially inhibiting the ability of mosquitoes to sense a human, the method comprising using a composition capable of releasing a spatially inhibiting effective amount of a spatial inhibiting compound effective against mosquitoes, said composition comprising (a) a spatial inhibiting compound comprising citral, l-carvone, and optionally citronella, and (b) optionally a carrier, wherein spatial inhibiting compound is present in an amount greater than about 75% by weight, based on the total weight of the composition.

8. The method according to claim 7 wherein the spatial inhibiting compound is present in an amount of about 80% or greater by weight, based on the total weight of the composition.

9. The method according to claim 7 wherein the citral and l-carvone are present in a weight ratio of citral:l-carvone from about 0.05:1 to about 1:0.05.

10. The method according to claim 7 wherein the spatial inhibiting compound is present in a carrier in a spatially inhibitory effective amount sufficient for spatially inhibiting mosquitoes from being able to sense their targets.

11. The method according to claim 7 wherein the composition is capable of releasing from about 0.000005-0.010 grams/hr/ft³ of the spatial inhibiting compound effective against mosquitoes.

12. A composition capable of releasing a spatially deterring/repelling/inhibiting effective amount of a spatial deterring/repelling/inhibiting compound effective against mosquitoes or biting midges, said composition comprising (a) a spatial deterring/repelling/inhibiting compound comprising citral, l-carvone, and optionally citronella, and (b) optionally a carrier, wherein the spatial deterring/repelling/inhibiting compound is present in an amount greater than about 75% by weight, based on the total weight of the composition.

13. The composition according to claim 12 wherein the spatial deterring/repelling/inhibiting compound is present in an amount of about 80% or greater by weight, based on the total weight of the composition.

14. The composition according to claim 12 wherein the citral and l-carvone are present in a weight ratio of citral:l-carvone from about 0.05:1 to about 1:0.05.

15. The composition according to claim 12 for spatially deterring/repelling/inhibiting mosquitoes.

16. The composition according to claim 12 wherein the spatial deterring/repelling/inhibiting compound is present in a spatially inhibitory effective amount sufficient for spatially inhibiting mosquitoes or biting midges from being able to sense their targets.

17. The composition according to claim 12 wherein the composition is capable of releasing from about 0.000005-0.010 grams/hr/ft³ of the spatial deterring/repelling/inhibiting compound effective against mosquitoes or biting midges.

18. The composition according to claim 12 which is formulated into a delivery system or vehicle, wherein the delivery system or vehicle comprises a heated or unheated evaporative device.

19. The composition according to claim 18 wherein the heated or unheated evaporative device is a candle.

20. A method of spatially deterring, repelling or inhibiting mosquitoes and biting midges, the method comprising using a composition capable of releasing a spatially deterring/repelling/inhibiting effective amount of a spatial deterring/repelling/inhibiting compound effective against mosquitoes and biting midges, said composition comprising (a) a spatial deterring/repelling/inhibiting compound comprising at least two of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and optionally citronella, and (b) optionally a carrier, wherein the spatial deterring/repelling/inhibiting compound is present in an amount greater than about 75% by weight, based on the total weight of the composition.

21. A composition capable of releasing a spatially deterring/repelling/inhibiting effective amount of a spatial deterring/repelling/inhibiting compound effective against mosquitoes or biting midges, said composition comprising (a) a spatial deterring/repelling/inhibiting compound comprising at least two of neryl acetate, citronellyl acetate, geranyl acetate, 8-hydroxy-p-cymene, citral, α-terpineol, citronellal, linaloyl acetate, citronellol, terpen-4-ol, tetrahydrocarvone, products of oxidized limonene inclusive of d- and l-carvone, (+) limonene oxide, (−) limonene oxide, cis and trans carveol, a diol and an aldehyde, and optionally citronella, and (b) optionally a carrier, wherein the spatial deterring/repelling/inhibiting compound is present in an amount greater than about 75% by weight, based on the total weight of the composition.
